(19) United States
(12) Patent Application Publication
(10) Pub. No.: US 2014/0281418 A1
(43) Pub. Date: Sep. 18, 2014

(54) Multiple Data Element-To-Multiple Data Element Comparison Processors, Methods, Systems, and Instructions

(71) Applicant: Shihjong J. Kuo, Hillsboro, OR (US)

(72) Inventor: Shihjong J. Kuo, Hillsboro, OR (US)

(21) Appl. No.: 13/828,274

(22) Filed: Mar. 14, 2013

(51) Int. Cl. G06F 9/38; G06F 9/30

(52) U.S. Cl. CPC G06F 9/3887; G06F 9/30098
USPC 712/220

(57) ABSTRACT

An apparatus includes packed data registers and an execution unit. An instruction is to indicate a first source packed data that is to include a first packed data elements, a second source packed data that is to include a second packed data elements, and a destination storage location. The execution unit, in response to the instruction, is to store a packed data result that is to include packed result data elements in the destination storage location. Each of the result data elements is to correspond to a different one of the data elements of the second source packed data. Each of the result data elements is to include a multiple bit comparison mask that is to include a different comparison mask bit for each different corresponding data element of the first source packed data compared with the corresponding data element of the second source packed data.

### BACKGROUND

1. Technical Field

Embodiments described herein generally relate to processors. In particular, embodiments described herein generally relate to processors to compare multiple data elements to multiple other data elements responsive to instructions.

2. Background Information

Many processors have Single Instruction, Multiple Data (SIMD) architectures. In SIMD architectures, a packed data instruction, vector instruction, or SIMD instruction may operate on multiple data elements or multiple pairs of data elements simultaneously or in parallel. The processor may have parallel execution hardware responsive to the packed data instruction to perform the multiple operations simultaneously or in parallel.

Multiple data elements may be packed within one register or memory location as packed data or vector data. In packed data, the bits of the register or other storage location may be logically divided into a sequence of data elements. For example, a 256-bit wide packed data register may have four 64-bit wide data elements, eight 32-bit data elements, sixteen 16-bit data elements, etc. Each of the data elements may represent a separate individual piece of data (e.g., a pixel color, etc.), which may be operated upon separately and/or independently of the others.

Comparison of packed data elements is a common and widespread operation that is used in many different ways. Various vector, packed data, or SIMD instructions for performing packed, vector, or SIMD comparisons of data elements are known in the arts. For example, MMX™ technology in Intel Architecture (IA) includes various packed compare instructions. More recently, Intel® Streaming SIMD Extensions 4.2 (SSE4.2) introduced several string and text processing instructions.

### BRIEF DESCRIPTION OF THE DRAWINGS

The invention may best be understood by referring to the following description and accompanying drawings that are used to illustrate embodiments. In the drawings:

FIG. 1 is a block diagram of an embodiment of a processor having an instruction set that includes one or more multiple data element-to-multiple data element comparison instructions.

FIG. 2 is a block diagram of an embodiment of an instruction processing apparatus having an execution unit operable to execute an embodiment of a multiple data element-to-multiple data element comparison instruction.

FIG. 3 is a block flow diagram of an embodiment of a method of processing an embodiment of a multiple data element-to-multiple data element comparison instruction.

FIG. 4 is a block diagram illustrating example embodiments of suitable packed data formats.

FIG. 5 is a block diagram illustrating an embodiment of an operation that may be performed in response to an embodiment of an instruction.

FIG. 6 is a block diagram illustrating an example embodiment of an operation that may be performed on 128-bit wide packed sources having 16-bit word elements in response to an embodiment of an instruction.

FIG. 7 is a block diagram illustrating an example embodiment of an operation that may be performed on 128-bit wide packed sources having 8-bit byte elements in response to an embodiment of an instruction.

FIG. 8 is a block diagram illustrating an example embodiment of an operation that may be performed in response to an embodiment of an instruction operable to select a subset of comparison masks to report in a packed data result.

FIG. 9 is a block diagram of microarchitectural details suitable for embodiments.

FIG. 10 is a block diagram of an example embodiment of a suitable set of packed data registers.

FIG. 11A illustrates an exemplary AVX instruction format including a VEX prefix, real opcode field, Mod R/M byte, SIB byte, displacement field, and IMM8.

FIG. 11B illustrates which fields from FIG. 11A make up a full opcode field and a base operation field.

FIG. 11C illustrates which fields from FIG. 11A make up a register index field.

FIG. 12A is a block diagram illustrating a generic vector friendly instruction format and class A instruction templates thereof according to embodiments of the invention.

FIG. 12B is a block diagram illustrating the generic vector friendly instruction format and class B instruction templates thereof according to embodiments of the invention.

FIG. 13 is a block diagram illustrating an exemplary specific vector friendly instruction format according to embodiments of the invention.

FIG. 13B is a block diagram illustrating the fields of the specific vector friendly instruction format that make up the full opcode field according to one embodiment of the invention.

FIG. 13C is a block diagram illustrating the fields of the specific vector friendly instruction format that make up the register index field according to one embodiment of the invention.

FIG. 13D is a block diagram illustrating the fields of the specific vector friendly instruction format that make up the augmentation operation field according to one embodiment of the invention.

FIG. 14 is a block diagram of a register architecture according to one embodiment of the invention.

FIG. 15A is a block diagram illustrating both an exemplary in-order pipeline and an exemplary register renaming, out-of-order issue/execution pipeline according to embodiments of the invention.

FIG. 15B is a block diagram illustrating both an exemplary embodiment of an in-order architecture core and an exemplary register renaming, out-of-order issue/execution architecture core to be included in a processor according to embodiments of the invention.

FIG. 16A is a block diagram of a single processor core, along with its connection to the on-die interconnect network and with its local subset of the Level 2 (L2) cache, according to embodiments of the invention.

FIG. 16B is an expanded view of part of the processor core in FIG. 16A according to embodiments of the invention.

FIG. 17 is a block diagram of a processor that may have more than one core, may have an integrated memory controller, and may have integrated graphics according to embodiments of the invention.

FIG. 18 shown is a block diagram of a system in accordance with one embodiment of the present invention.

FIG. 19 shown is a block diagram of a first more specific exemplary system in accordance with an embodiment of the present invention.

FIG. 20 shown is a block diagram of a second more specific exemplary system in accordance with an embodiment of the present invention.

FIG. 21 shown is a block diagram of a SoC in accordance with an embodiment of the present invention.

FIG. 22 is a block diagram contrasting the use of a software instruction converter to convert binary instructions in a source instruction set to binary instructions in a target instruction set according to embodiments of the invention.

### DETAILED DESCRIPTION OF EMBODIMENTS

In the following description, numerous specific details are set forth (e.g., specific instruction operations, packed data formats, types of masks, ways of indicating operands, processor configurations, microarchitectural details, sequences of operations, etc.). However, embodiments may be practiced without these specific details. In other instances, well-known circuits, structures and techniques have not been shown in detail to avoid obscuring the understanding of the description.

Disclosed herein are various multiple data element-to-multiple data element comparison instructions, processors to execute the instructions, methods performed by the processors when processing or executing the instructions, and systems incorporating one or more processors to process or execute the instructions. FIG. 1 is a block diagram of an embodiment of a processor 100 having an instruction set 102 that includes one or more multiple data element-to-multiple data element comparison instructions 103. In some embodiments, the processor may be a general-purpose processor (e.g., a general-purpose microprocessor of the type used in desktop, laptop, and like computers). Alternatively, the processor may be a special-purpose processor. Examples of suitable special-purpose processors include, but are not limited to, network processors, communications processors, cryptographic processors, graphics processors, co-processors, embedded processors, digital signal processors (DSPs), and controllers (e.g., microcontrollers), to name just a few examples. The processor may be any of various complex instruction set computing (CISC) processors, various reduced instruction set computing (RISC) processors, various very long instruction word (VLIW) processors, various hybrids thereof, or other types of processors entirely.

The processor has an instruction set architecture (ISA) 101. The ISA represents a part of the architecture of the processor related to programming and commonly includes the native instructions, architectural registers, data types, addressing modes, memory architecture, and the like, of the processor. The ISA is distinguished from the microarchitecture, which generally represents the particular processor design techniques selected to implement the ISA.

The ISA includes architecturally-visible registers (e.g., an architectural register file) 107. The architectural registers may also be referred to herein simply as registers. Unless otherwise specified or apparent, the phrases architectural register, register file, and register are used herein to refer to registers that are visible to the software and/or programmer and/or the registers that are specified by general-purpose macroinstructions to identify operands. These registers are contrasted to other non-architectural or non-architecturally visible registers in a given microarchitecture (e.g., temporary registers used by instructions, reorder buffers, retirement registers, etc.). The registers generally represent on-die processor storage locations. The illustrated registers include packed data registers 108 that operable to store packed data, vector data, or SIMD data. The architectural registers may also include general-purpose registers 109, which in some embodiments are optionally indicated by the multiple element-to-multiple element comparison instructions to provide source operands (e.g., to indicate subsets of data elements, to provide offsets that indicate comparison results to be included in the destination, etc.).

The illustrated ISA includes an instruction set 102. The instructions of the instruction set represent macroinstructions (e.g., assembly language or machine-level instructions provided to the processor for execution), as opposed to microinstructions or micro-ops (e.g., those which result from decoding the macroinstructions). The instruction set includes one or more multiple data element-to-multiple data element comparison instructions 103. Various different embodiments of multiple data element-to-multiple data element comparison instructions will be disclosed further below. In some embodiments, the instructions 103 may include one or more all data element-to-all data element comparison instructions 104. In some embodiments, the instructions 103 may include one or more specified subset-to-all, or specified subset-to-specified subset comparison instructions 105. In some embodiments, the instructions 103 may include one or more multiple element-to-multiple element comparison instructions operable to select (e.g., indicate an offset to selects) a portion of a comparison that is to be stored in a destination.

The processor also includes execution logic 110. The execution logic is operable to execute or process the instructions of the instruction set (e.g., the multiple data element-to-multiple data element comparison instructions 103). In some embodiments, the execution logic may include particular logic (e.g., particular circuitry or hardware potentially combined with firmware) to execute these instructions.

FIG. 2 is a block diagram of an embodiment of an instruction processing apparatus 200 having an execution unit 210 that is operable to execute an embodiment of a multiple data element-to-multiple data element comparison instruction 203. In some embodiments, the instruction processing apparatus may be a processor and/or may be included in a processor. For example, in some embodiments, the instruction processing apparatus may be, or may be included in, the processor of FIG. 1. Alternatively, the instruction processing apparatus may be included in a similar or different processor. Moreover, the processor of FIG. 1 may include either a similar or different instruction processing apparatus.

The apparatus 200 may receive the multiple data element-to-multiple data element comparison instruction 203. For example, the instruction may be received from an instruction fetch unit, an instruction queue, or the like. The multiple data element-to-multiple data element comparison instruction may represent a machine code instruction, assembly language instruction, macroinstruction, or control signal of an ISA of the apparatus. The multiple data element-to-multiple data element comparison instruction may explicitly specify (e.g., through one or more fields or a set of bits), or otherwise indicate (e.g., implicitly indicate), a first source packed data 213 (e.g., in a first source packed data register 212), may specify or otherwise indicate a second source packed data 215 (e.g., in a second source packed data register 214), and may specify or otherwise indicate (e.g., implicitly indicate) a destination storage location 216 where a packed data result 217 is to be stored.

The illustrated instruction processing apparatus includes an instruction decode unit or decoder 211. The decoder may receive and decode the relatively higher-level machine code or assembly language instructions or macroinstructions, and output one or more relatively lower-level microinstructions, micro-operations, micro-code entry points, or other relatively lower-level instructions or control signals that reflect, represent, and/or are derived from the higher-level instructions. The one or more lower-level instructions or control signals may implement the higher-level instruction through one or more lower-level (e.g., circuit-level or hardware-level) operations. The decoder may be implemented using various different mechanisms including, but not limited to, microcode read only memories (ROMs), look-up tables, hardware implementations, programmable logic arrays (PLAs), and other mechanisms used to implement decoders known in the art.

In other embodiments, an instruction emulator, translator, morpher, interpreter, or other instruction conversion logic may be used. Various different types of instruction conversion logic are known in the arts and may be implemented in software, hardware, firmware, or a combination thereof. The instruction conversion logic may receive the instruction and emulate, translate, morph, interpret, or otherwise convert the instruction into one or more corresponding derived instructions or control signals. In other embodiments, both instruction conversion logic and a decoder may be used. For example, the apparatus may have instruction conversion logic to convert a received machine code instruction into one or more intermediate instructions, and a decoder to decode the one or more intermediate instructions into one or more lower-level instructions or control signals executable by native hardware of the apparatus (e.g., an execution unit). Some or all of the instruction conversion logic may be located outside the instruction processing apparatus, such as, for example, on a separate die and/or in a memory.

The apparatus 200 also includes a set of packed data registers 208. Each of the packed data registers may represent an on-die storage location that is operable to store packed data, vector data, or SIMD data. In some embodiments, the first source packed data 213 may be stored in a first source packed data register 212, the second source packed data 215 may be stored in the second source packed data register 214, and the packed data result 217 may be stored in destination storage location 216, which may be a third packed data register. Alternatively, memory locations, or other storage locations, may be used for one or more of these. The packed data registers may be implemented in different ways in different microarchitectures using well-known techniques and are not limited to any particular type of circuit. Various different types of registers are suitable. Examples of suitable types of registers include, but are not limited to, dedicated physical registers, dynamically allocated physical registers using register renaming, and combinations thereof.

Referring again to FIG. 2, the execution unit 210 is coupled with the decoder 211 and the packed data registers 208. By way of example, the execution unit may include an arithmetic logic unit, a digital circuit to perform arithmetic and logical operations, a logical unit, an execution unit or functional unit including comparison logic to compare data elements, or the like. The execution unit may receive one or more decoded or otherwise converted instructions or control signals that represent and/or are derived from the multiple data element-to-multiple data element comparison instruction 203. The instruction may specify or otherwise indicate the first source packed data 213 (e.g., specify or otherwise indicate the first packed data register 212) that is to include the first plurality of packed data elements, specify or otherwise indicate the second source packed data 215 (e.g., specify or otherwise indicate the second packed data register 214) that is to include the second plurality of packed data elements, and specify or otherwise indicate the destination storage location 216.

The execution unit is operable in response to and/or as a result of the multiple data element-to-multiple data element comparison instruction 203 to store the packed data result 217 in the destination storage location 216. The execution unit and/or the instruction processing apparatus may include specific or particular logic (e.g., circuitry or other hardware potentially combined with firmware and/or software) that is operable to execute the multiple data element-to-multiple data element comparison instruction 203 and store the result 217 in response to the instruction (e.g., in response to one or more instructions or control signals decoded or otherwise derived from the instruction).

The packed data result 217 may include a plurality of packed result data elements. In some embodiments, each of the packed result data elements may have a multiple bit comparison mask. For example, in some embodiments, each of the packed result data elements may correspond to a different one of the packed data elements of the second source packed data 215. In some embodiments, each of the packed result data elements may include a multiple bit comparison mask that is to indicate results of comparisons of multiple packed data elements of the first source packed data with the packed data element of the second source that is to correspond to the packed result data element. In some embodiments, each of the packed result data elements may include a multiple bit comparison mask that corresponds to, and indicates comparison results for, the corresponding packed data element of the second source packed data 215. In some embodiments, each multiple bit comparison mask may include a different comparison mask bit for each different corresponding packed data element of the first source packed data 213 that is to be compared with the associated/corresponding packed data element of the second source packed data 215. In some embodiments, each comparison mask bit may indicate a result of a corresponding comparison. In some embodiments, each mask indicates how many matches there are with the corresponding data element from the second source packed data, at what positions in the first source packed data the matches occur.

In some embodiments, the multiple bit comparison mask within a given packed result data element may indicate which of the packed data elements of the first source packed data 213 equal the packed data element of the second source packed data 215 that corresponds to the given packed result data element. In some embodiments, the comparison may be for equality, and each comparison mask bit may either have a first binary value (e.g., be set to binary one according to one possible convention) to indicate that the compared data elements are equal, or have a second binary value (e.g., be cleared to binary zero) to indicate that the compared data elements are not equal. In other embodiments, other comparisons (e.g., greater than, less than, etc.) may optionally be used.

In some embodiments, the packed data result may indicate results of comparisons of all of the data elements of the first source packed data with all of the data elements of the second source packed data. In other embodiments, the packed data result may indicate results of comparisons of only a subset of data elements of one of the source packed data with either all, or only a subset of the data elements of, another of the source packed data. In some embodiments, the instruction may specify or otherwise indicate the subset or subsets to be compared. For example, in some embodiments, the instruction may optionally explicitly specify or implicitly indicate a first subset 218, for example in an implicit register of the general-purpose registers 209, and optionally a second subset 219, for example in an implicit register of the general-purpose registers 209, to be used to limit the comparisons to only a subset of the first and/or the second source packed data.

To avoid obscuring the description, a relatively simple instruction processing apparatus 200 has been shown and described. In other embodiments, the apparatus may optionally include other well-known components found in processors. Examples of such components include, but are not limited to, a branch prediction unit, an instruction fetch unit, instruction and data caches, instruction and data translation lookaside buffers, prefetch buffers, microinstruction queues, microinstruction sequencers, a register renaming unit, an instruction scheduling unit, bus interface units, second or higher level caches, a retirement unit, other components included in processors, and various combinations thereof. There are literally numerous different combinations and configurations of components in processors, and embodiments are not limited to any particular combination or configuration. Embodiments may be included in processors have multiple cores, logical processors, or execution engines at least one of which has execution logic operable to execute an embodiment of an instruction disclosed herein.

FIG. 3 is a block flow diagram of an embodiment of a method 325 of processing an embodiment of a multiple data element-to-multiple data element comparison instruction. In various embodiments, the method may be performed by a general-purpose, special-purpose processor, or other instruction processing apparatus or digital logic device. In some embodiments, the operations and/or method of FIG. 3 may be performed by and/or within the processor of FIG. 1 and/or the apparatus FIG. 2. The components, features, and specific optional details described herein for the processor and apparatus of FIGS. 1-2 also optionally apply to the operations and/or method of FIG. 3. Alternatively, the operations and/or method of FIG. 3 may be performed by and/or within a similar or entirely different processor or apparatus. Moreover, the processor of FIG. 1 and/or the apparatus of FIG. 2 may perform operations and/or methods the same as, similar to, or entirely different than those of FIG. 3.

The method includes receiving the multiple data element-to-multiple data element comparison instruction, at block 326. In various aspects, the instruction may be received at a processor, an instruction processing apparatus, or a portion thereof (e.g., an instruction fetch unit, a decoder, an instruction converter, etc.). In various aspects, the instruction may be received from an off-die source (e.g., from main memory, a disc, or interconnect), or from an on-die source (e.g., from an instruction cache). The multiple data element-to-multiple data element comparison instruction may specify or otherwise indicate a first source packed data having a first plurality of packed data elements, a second source packed data having a second plurality of packed data elements, and a destination storage location.

A packed data result including a plurality of packed result data elements may be stored in the destination storage location in response to and/or as a result of the multiple data element-to-multiple data element comparison instruction, at block 327. Representatively, an execution unit, instruction processing apparatus, or general-purpose or special-purpose processor may perform the operation specified by the instruction and store the packed data result. In some embodiments, each of the packed result data elements may correspond to a different one of the packed data elements of the second source packed data. In some embodiments, each of the packed result data elements may include a multiple bit comparison mask. In some embodiments, each multiple bit comparison mask may include a different mask bit for each different corresponding packed data element of the first source packed data, which has been compared with the packed data element of the second source that corresponds to the packed result data element. In some embodiments, each mask bit may indicate a result of a corresponding comparison. Other optional details mentioned above in conjunction with FIG. 2 may also optionally be included in the method which may optionally process the same instruction and/or optionally be performed within the same apparatus.

The illustrated method involves architecturally visible operations (e.g., those visible from a software perspective). In other embodiments, the method may optionally include one or more microarchitectural operations. By way of example, the instruction may be fetched, decoded, potentially scheduled out of order, source operands may be accessed, execution logic may be enabled to perform microarchitectural operations to implement the instruction, the execution logic may perform the microarchitectural operations, results may optionally be reordered back into program order, etc. Different microarchitectural ways of performing the operation are contemplated. For example, in some embodiments, comparison mask bit zero extension operations, packed shift left logical operations, and logical OR operations, such as, for example, those that will be described in conjunction with FIG. 9, may optionally be performed. In other embodiments, any of these microarchitectural operations may optionally be added to the method of FIG. 3, although the method may also be implemented by other, different microarchitectural operations.

FIG. 4 is a block diagram illustrating several example embodiments of suitable packed data formats. A 128-bit packed byte format 428 is 128-bits wide and includes sixteen 8-bit wide byte data elements, labeled in the illustration from least to most significant bit positions, as B1-B16. A 256-bit packed word format 429 is 256-bits wide and includes sixteen 16-bit wide word data elements, labeled in the illustration from least to most significant bit positions, as W1-W16. The 256-bit format is shown as split into two pieces to fit on the page, although the entire format may be included in a single physical register or logical register, in some embodiments. These are just a few illustrative examples.

Other packed data formats are also suitable. For example, other suitable 128-bit packed data formats include a 128-bit packed 16-bit word format and a 128-bit packed 32-bit doubleword format. Other suitable 256-bit packed data formats include 256-bit packed 8-bit byte format and 256-bit packed 32-bit doubleword format. Smaller packed data formats than 128-bits are also suitable, such as 64-bit wide packed data 8-bit byte format. Larger packed data formats than 256-bits are also suitable, such as 512-bit wide or wider packed 8-bit byte, 16-bit word, or 32-bit doubleword formats. Generally, the number of packed data elements in the packed data operand is equal to the size in bits of the packed data operand divided by the size in bits of the packed data elements.

FIG. 5 is a block diagram illustrating an embodiment of a multiple data element-to-multiple data element comparison operation 539 that may be performed in response to an embodiment of a multiple data element-to-multiple data element comparison instruction. The instruction may specify or otherwise indicate a first source packed data 513 including a first set of N packed data elements 540-1 through 540-N, and may specify or otherwise indicate a second source packed data 515 including a second set of N packed data elements 541-1 through 541-N. In the illustrated example, in the first source packed data 513, a first least significant data element 540-1 stores data representing the value A, a second data element 540-2 stores data representing the value B, a third data element 540-3 stores data representing the value C, and an Nth most significant data element 540-N stores data representing the value B. In the illustrated example, in the second source packed data 515, a first least significant data element 541-1 stores data representing the value B, a second data element 541-2 stores data representing the value A, a third data element 541-3 stores data representing the value B, and an Nth most significant data element 541-N stores data representing the value A.

The number N may be equal to the size in bits of the source packed data divided by the size in bits of the packed data elements. Commonly, the number N may be an integer often ranging from about four to on the order of about sixty four, or even larger. Specific examples of N include, but are not limited to, four, eight, sixteen, thirty two, and sixty four. In various embodiments, the width of the source packed data may be 64-bits, 128-bits, 256-bits, 512-bits, or even wider, although the scope of the invention is not limited to just these widths. In various embodiments, the width of the packed data elements may be 8-bit bytes, 16-bit words, or 32-bit doublewords, although the scope of the invention is not limited to just these widths. Commonly, in embodiments where the instruction is used for string and/or text fragment comparisons, the widths of the data elements may commonly be either 8-bit bytes or 16-bit words, since most alphanumeric values of interest can be represented in 8-bit bytes or at least in 16-bit words, although wider formats (e.g., 32-bit doubleword formats) may be used if desired (e.g., for compatibility with other operations, to avoid format conversions, for efficiency, etc.). In some embodiments, the data elements in the first and second source packed data may be either signed or unsigned integers.

In response to the instruction, a processor or other apparatus may be operable to generate and store a packed data result 517 in a destination storage location 516 that is specified or otherwise indicated by the instruction. In some embodiments, the instruction may cause the processor or other apparatus to generate an all data element-by-all data element comparison mask 542 as an intermediate result. The all-by-all comparison mask 542 may include N×N comparisons results for N×N comparisons that are to be performed between each/all of the N data elements of the first source packed data and each/all of the N data elements of the second source packed data. That is, an all element-to-all element comparison may be performed.

In some embodiments, each comparison result in the mask may indicate a result of a comparison of the compared data elements for equality, and each comparison result may be a single bit that may have either a first binary value (e.g., be set to binary one or be logically true) to indicate that the compared data elements are equal, or have a second binary value (e.g., be cleared to binary zero or be logically false) to indicate that the compared data elements are not equal. The other convention is also possible. As shown, a binary-0 is shown in the top right corner of the all-by-all comparison mask for the comparison of the first data element 540-1 (representing the value of “A”) of the first source packed data 513 with the first data elements 541-1 (representing the value of “B”) of the second source packed data 515 since these values are unequal. In contrast, a binary-1 is shown one position to the left of that position in the all-by-all comparison mask for the comparison of the first data element 540-1 (representing the value of “A”) of the first source packed data 513 with the second data elements 541-2 (representing the value of “A”) of the second source packed data 515 since these values are equal. Sequences of matching values appear in the all-by-all comparison mask as binary-1's along a diagonal as shown by the circled set of diagonal ones. The all-by-all comparison mask is a microarchitectural aspect optionally generated in some embodiments, but is not required to be generated in other embodiments. Rather the result in the destination may be generated and stored without the intermediate result.

Referring again to FIG. 5, in some embodiments, the packed data result 517 that is to be stored in the destination storage location 516 may include a set of N, N-bit comparison masks. For example, the packed data result may include a set of N packed result data elements 544-1 through 544-N. In some embodiments, each of the N packed result data elements 544-1 through 544-N may correspond to one of the N packed data elements 541-1 through 541-N of the second source packed data 515 in a corresponding relative position. For example, a first packed result data element 544-1 may correspond to a first packed data element 541-1 of the second source, a third packed result data element 544-3 may correspond to a third packed data element 541-3 of the second source, and so on. In some embodiments, each of the N packed result data elements 544 may have an N-bit comparison mask. In some embodiments, each N-bit comparison mask may correspond to, and indicate comparison results for, the corresponding packed data element 541 of the second source packed data 515. In some embodiments, each N-bit comparison mask may include a different comparison mask bit for each of the N different corresponding packed data elements of the first source packed data 513 which are to be compared (according to the instruction including if the instruction indicates a subset are to be compared) with the associated/corresponding packed data element of the second source packed data 515.

In some embodiments, each comparison mask bit may indicate a result of a corresponding comparison (e.g., be binary-1 if the compared values are equal or be binary-0 if they are not equal). For example, a bit k of an N-bit comparison mask may represent a comparison result for a comparison of a k^{th} data element of a first source packed data with a data element of the second source packed data to which the whole N-bit comparison mask corresponds. At least conceptually, each mask bit may represent a sequence of mask bits from a single column of the all-by-all comparison mask 542. For example, the first result packed data element 544-1 includes the values (from right to left) “0, 1, 0, . . . 1” which may indicate that the value “B” in the first data element 541-1 (to which the N-bit mask corresponds) of the second source 515 does not equal the value “A” in the first data element 540-1 of the first source, equals the value “B” in the second data element 540-2 of the first source, does not equal the value “C” in the third data element 540-3 of the first source, and equals the value “B” in the Nth data element 540-N of the first source. In some embodiments, each mask indicates how many matches there are with the corresponding data element from the second source packed data, at what positions in the first source packed data the matches occur.

FIG. 6 is a block diagram illustrating an example embodiment of a comparison operation 639 that may be performed on 128-bit wide packed sources having 16-bit word elements in response to an embodiment of an instruction. The instruction may specify or otherwise indicate a first source 128-bit wide packed data 613 including a first set of eight packed 16-bit word data elements 640-1 through 640-8, and may specify or otherwise indicate a second source 128-bit wide packed data 615 including a second set of eight packed 16-bit word data elements 641-1 through 641-8.

In some embodiments, the instruction may optionally specify or otherwise indicate an optional third source 647 (e.g., an implicit general-purpose register) to indicate how many (e.g., a subset) of the data elements of the first source packed data are to be compared and/or an optional fourth source 648 (e.g., an implicit general-purpose register) to indicate how many (e.g., a subset) of the data elements of the second source packed data are to be compared. Alternatively, one or more immediates of the instruction may be used to provide this information. In the illustrated example, the third source 647 provides that only the least significant five of the eight data elements of the first source packed data are to be compared, and the fourth source 648 provides that all eight data elements of the second source packed data are to be compared, although this is just one illustrative example.

In response to the instruction, a processor or other apparatus may be operable to generate and store a packed data result 617 in a destination storage location 616 that is specified or otherwise indicated by the instruction. In some embodiments, in which one or more subsets are indicated by the third source 647 and/or the fourth source 648, the instruction may cause the processor or other apparatus to generate an all valid data element-by-all valid data element comparison mask 642 as an intermediate result. The all valid-by-all valid comparison mask 642 may include comparisons results for the subset of the comparisons that are to be performed according to the values in the third and fourth sources. In this particular example, forty comparison results (i.e., 8×5) are generated. In some embodiments, bits of the comparison mask for which the comparisons are not to be performed (e.g., those for the most significant three data elements of the first source) may be forced to a predetermined value, for example forced to binary-0 as shown in the illustration by “F0”.

In some embodiments, the packed data result 617 that is to be stored in the destination storage location 616 may include a set of eight, 8-bit comparison masks. For example, the packed data result may include a set of eight packed result data elements 644-1 through 644-N. In some embodiments, each of these eight packed result data elements 644 may correspond to one of the eight packed data elements 641 of the second source packed data 615 in a corresponding relative position. In some embodiments, each of the eight packed result data elements 644 may have an 8-bit comparison mask. In some embodiments, each 8-bit comparison mask may correspond to, and indicate comparison results for, the corresponding packed data element 641 of the second source packed data 615. In some embodiments, each 8-bit comparison mask may include a different comparison mask bit for each valid of the eight different corresponding packed data elements of the first source packed data 613 which are to be compared (e.g., according to the value in the third source) with the associated/corresponding packed data element of the second source packed data 615. The other of the 8-bits may be forced (e.g., F0) bits. As before, at least conceptually, each 8-bit mask may represent a sequence of mask bits from a single column of the mask 642.

FIG. 7 is a block diagram illustrating an example embodiment of a comparison operation 739 that may be performed on 128-bit wide packed sources having 8-bit byte elements in response to an embodiment of an instruction. The instruction may specify or otherwise indicate a first source 128-bit wide packed data 713 including a first set of sixteen packed 8-bit byte data elements 740-1 through 740-16, and may specify or otherwise indicate a second source 128-bit wide packed data 715 including a second set of sixteen packed 8-bit byte data elements 741-1 through 741-16.

In some embodiments, the instruction may optionally specify or otherwise indicate an optional third source 747 (e.g., an implicit general-purpose register) to indicate how many (e.g., a subset) of the data elements of the first source packed data are to be compared and/or the instruction may optionally specify or otherwise indicate an optional fourth source 748 (e.g., an implicit general-purpose register) to indicate how many (e.g., a subset) of the data elements of the second source packed data are to be compared. In the illustrated example, the third source 747 provides that only the least significant fourteen of the sixteen data elements of the first source packed data are to be compared, and the fourth source 748 provides that only a least significant fifteen of the sixteen data elements of the second source packed data are to be compared, although this is just one illustrative example. In other embodiments, most significant or intermediate ranges may also optionally be used. These values may be specified in different ways, such as numbers, positions, indexes, intermediate ranges, etc.

In response to the instruction, a processor or other apparatus may be operable to generate and store a packed data result 717 in a destination storage location 716 that is specified or otherwise indicated by the instruction. In some embodiments, in which one or more subsets are indicated by the third source 747 and/or the fourth source 748, the instruction may cause the processor or other apparatus to generate an all valid data element-by-all valid data element comparison mask 742 as an intermediate result. This may be similar to those previously described, or different.

In some embodiments, the packed data result 717 may include a set of sixteen, 16-bit comparison masks. For example, the packed data result may include a set of sixteen packed result data elements 744-1 through 744-16. In some embodiments, the destination storage location may represent a 256-bit register or other storage location, which is twice as wide as each of the first and second source packed data. In some embodiments, an implicit destination register may be used. In other embodiments, the destination register may be specified, for example using an Intel Architecture Vector Extensions (VEX) coding scheme. As another option, two 128-bit registers or other storage locations may optionally be used. In some embodiments, each of these sixteen packed result data elements 744 may correspond to one of the sixteen packed data elements 741 of the second source packed data 715 in a corresponding relative position. In some embodiments, each of the sixteen packed result data elements 744 may have a 16-bit comparison mask. In some embodiments, each 16-bit comparison mask may correspond to, and indicate comparison results for, the corresponding packed data element 741 of the second source packed data 715. In some embodiments, each 16-bit comparison mask may include a different comparison mask bit for each valid of the sixteen different corresponding packed data elements of the first source packed data 713 which are to be compared (e.g., according to the value in the third source) with each valid of the associated/corresponding packed data element of the second source packed data 715 (e.g., according to the value in the fourth source). The other of the 16-bits may be forced (e.g., F0) bits.

Still other embodiments are contemplated. For example, in some embodiments, the first source packed data may have eight 8-bit packed data elements, the second source packed data may have eight 8-bit packed data elements, and the packed data result may have eight 8-bit packed result data elements. In still other embodiments, the first source packed data may have thirty-two 8-bit packed data elements, the second source packed data may have thirty-two 8-bit packed data elements, and the packed data result may have thirty-two 32-bit packed result data elements. That is, in some embodiments, there may be as many masks in the destination as there are source data elements in each source operand, and each mask may have as many bits as there are source data elements in each source operand.

In one aspect, the pseudocode below may represent the operation of the instruction of FIG. 7. In this pseudocode, EAX and EDX are implicit general-purpose registers used to indicate subsets of the first and second sources, respectively.

```
      Bound1 = Min (16, EAX);
      Bound2 = Min (16, EDX);
      For (j = 0; j < 16; j ++ ) {
      Dest [255:0] <- 0;
        For (k = 0; k < 16; k ++) {
        If (j < Bound1 && k < Bound2) Bitplane[k][j] <- (src1[j]
equal src2[k]) ? 1 : 0;
        Else Bitplane[k][j] <-0;
        Dest[16*k+j:16*k] <- Dest[16*k+j:16*k] | (bitplane[k][j]<<j);
        }
      }
```

FIG. 8 is a block diagram illustrating an example embodiment of a comparison operation 839 that may be performed on 128-bit wide packed sources having 8-bit byte elements in response to an embodiment of an instruction in which the instruction is operable to specify or indicate an offset 850 to select a subset of comparison masks to report in a packed data result 818. The operation is similar to that shown and described for FIG. 7 and the optional details and aspects described for FIG. 7 may optionally be used with the embodiment of FIG. 8. To avoid obscuring the description, the different or additional aspects will be described without repeating the optional similarities.

As in FIG. 7, each of the first and second sources is 128-bits wide and includes sixteen 8-bit byte data elements each. An all-to-all comparison of these operands would produce 256-bits of comparison bits (i.e., 16×16). In one aspect, this may be arranged as sixteen 16-bit comparison masks, as described elsewhere herein.

In some embodiments, for example in order to use a 128-bit register or other storage location instead of a 256-bit register or other storage location, the instruction may optionally specify or otherwise indicate an optional offset 850. In some embodiments, the offset may be specified by a source operand (e.g., through an implicit register), or an immediate of the instruction, or otherwise. In some embodiments, the offset may select a subset or portion of a full all-to-all comparison result to be reported in a result packed data. In some embodiments, the offset may indicate a starting point. For example, it may indicate a first comparison mask to include in the packed data result. As shown in the illustrated example, embodiment, the offset may indicate a value of two to specify that the first two comparison masks are to be skipped over and not reported in the result. As shown, based on this offset of two, the packed data result 818 may store a third 744-3 through a tenth 744-10 of sixteen possible 16-bit comparison masks. In some embodiments, the third 16-bit comparison mask 744-3 may correspond to the third packed data element 741-3 of the second source, and the tenth 16-bit comparison mask 744-10 may correspond to the tenth packed data element 741-10 of the second source. In some embodiments, the destination is an implicit register, although this is not required.

FIG. 9 is a block diagram illustrating an embodiment of a microarchitectural approach that may optionally be used to implement embodiments. A portion of execution logic 910 is shown. The execution logic includes all valid-by-all valid element comparison logic 960. The all valid-by-all valid element comparison logic is operable to compare all valid elements with all other valid elements. These comparisons may be done in parallel, in series, or partly in parallel and partly in series. Each of these comparisons may be done using substantially conventional comparison logic, for example, similar to that used for comparisons performed in packed compare instructions. The all valid-by-all valid element comparison logic may generate an all valid-by-all valid comparison mask 942. By way of example, the portion of the mask 942 may represent the two rightmost columns of the mask 642 of FIG. 6. The all valid-by-all valid element comparison logic may also represent an embodiment of all valid-by-all valid comparison mask generation logic.

The execution logic also includes mask bit zero extend logic 962 coupled with the comparison logic 960. The mask bit zero extend logic may be operable to zero extend each of the single bit comparison results of the all valid-by-all valid element comparison mask 942. As shown, in this case of ultimately generating 8-bit masks, in some embodiments, zeros may be filled in each of the more significant 7-bits. The single bit mask bits from the mask 942 now occupy the least significant bit, will all more significant bits being zeros.

The execution logic also includes shift left logical mask bit alignment logic 964 coupled with the mask bit zero extend logic 962. The shift left logical mask bit alignment logic may be operable to shift the zero extended mask bits left logically. As shown, in some embodiments, the zero extended mask bits may be shifted left logically by different shift amounts in order to help achieve alignment. In particular, the first row may be shifted left logically by 7-bits, the second row by 6-bits, the third row by 5-bits, the fourth row by 4-bits, the fifth row by 3-bits, and so on. The shifted elements may be zero extended on the least significant end for all bits shifted out. This helps to achieve alignment of the mask bits for the result masks.

The execution logic also includes column OR logic 966 coupled with the shift left logical mask bit alignment logic 964. The column OR logic may be operable to logically OR a column of the logically left shifted and aligned elements from the alignment logic 964. This column OR operation may combine all of the single mask bits from each of the different rows within the column into their now aligned positions in a single result data element which in this case is an 8-bit mask. This operation effectively “transposes” the set mask bits in the columns of the original comparison mask 942 into different comparison result mask data elements.

It is to be appreciated that this is just one illustrative example of a suitable microarchitecture. Other embodiments may use other operations to achieve a similar data processing or rearrangement. For example, a matrix transpose type of operation may optionally be performed, or bits may merely be routed to the intended locations.

The instructions disclosed herein are general-purpose comparison instructions. Those skilled in the arts will devise various uses of these instructions for a wide variety of purposes/algorithms. In some embodiments, the instructions disclosed herein may be used to help accelerate the identification of sub-pattern relationship of two textual patterns.

Advantageously, embodiments of the instructions disclosed herein may be relatively more useful for sub-pattern detection, at least in certain instances, than other instructions known in the arts. To further illustrate, it may be helpful to consider an example. Consider the embodiment shown and described above for FIG. 6. In this embodiment, for this data, there is: (1) one prefix match of length 3 at position 1; (2) one mid-fix match of length 3 at position 5; (3) one prefix match of length 1 at position 7; and (4) additional non-prefix match of length 1. If the same data were processed by the SSE4.2 instruction PCMPESTRM, less matches would be detected. For example, PCMPESTRM may only detect one prefix match of length 1 at position 7. In order for PCMPESTM to be able to detect the sub-pattern of (1), the src2 may need to be shifted by one and reloaded into the register and execute another PCMESTRM instruction. In order for PCMPESTM to be able to detect the sub-pattern of (2), the src1 may need to be shifted one byte and reloaded, and another PCMESTRM instruction executed. More generally, for a needle that is m-bytes, and a haystack in a register that is n-bytes, where m<n, PCMPESTRM may detect only: (1) m-byte match at position 0 thru n−m−1, (2) at position n−m thru n−1, sub-prefix match of lengths of m−1 . . . 1, respectively. In contrast, various embodiments shown and described herein are able to detect more, and in some embodiments, all possible combinations. As a result, embodiments of the instructions disclosed herein may help to increase the speed and efficiency of various different patter and/or sub-pattern detection algorithms known in the arts. In some embodiments, the instructions disclosed herein may be used for comparing molecular and/or biological sequences. Examples of such sequences include, but are not limited to, DNA sequences, RNA sequences, protein sequences, amino acid sequences, nucleotide sequences, and the like. Protein, DNA, RNA, and other such sequencing generally tends to be a computational intensive task. Such sequence often involves searching genetic sequence databases or libraries against a target or reference DNA/RNA/protein sequence/fragment/keyword of amino acids or nucleotides. Alignment of a gene fragment/keyword against millions of known sequences in the databases usually starts with discovering the spatial relationships between an input pattern against an archived sequence. An input pattern of a given size is typically treated as a collection of sub-pattern of alphabets. The sub-pattern of alphabets may represent a “needle.” These alphabets may be included in a first source packed data of the instructions disclosed herein. Different portions of the database/library may be included in different instances of the instructions in the second source packed data operands.

The library or database may represent a “haystack” that is being searched as part of an algorithm to attempt to locate the needle in the haystack. Different instances of the instruction may use the same needle and different portions of the haystack until the entire haystack has been searched in an attempt to find the needle. The alignment score of a given spatially aligned relationship is evaluated based on matched and non-matched sub-patterns of the input against each archival sequence. Sequence alignment tools may use results of the comparisons as part of evaluating the function, structure and evolution between vast families of DNA/RNA and other amino acid sequences. In one aspect, the alignment tools may evaluate alignment scores starting from sub-patterns of only a few alphabets. The double nested loops may to cover two dimensional search spaces at a certain granularity, such as byte-granularity. Advantageously, the instructions disclosed herein may help to significantly accelerate such searching/sequencing. For example, it is currently thought that instructions similar to those of FIG. 7 may help to reduce the nesting loop structure by on the order of 16×16 and that instructions similar to those of FIG. 8 may help to reduce the nesting loop structure by on the order of 16×8.

Instructions disclosed herein may have an instruction format that includes an operation code or opcode. The opcode may represent a plurality of bits or one or more fields that are operable to identify the instruction and/or the operation to be performed. The instruction format may also include one or more source specifiers and a destination specifier. By way of example, each of these specifiers may include bits or one or more fields to specify an address of a register, memory location, or other storage location. In other embodiments, instead of an explicit specifier a source or destination may instead be implicit to the instruction. In other embodiments, information specified in a source register or other source storage location may instead be specified through an immediate of the instruction.

FIG. 10 is a block diagram of an example embodiment of a suitable set of packed data registers 1008. The illustrated packed data registers include thirty-two 512-bit packed data or vector registers. These thirty-two 512-bit registers are labeled ZMM0 through ZMM31. In the illustrated embodiment, the lower order 256-bits of the lower sixteen of these registers, namely ZMM0-ZMM15, are aliased or overlaid on respective 256-bit packed data or vector registers labeled YMM0-YMM15, although this is not required. Likewise, in the illustrated embodiment, the lower order 128-bits of YMM0-YMM15 are aliased or overlaid on respective 128-bit packed data or vector registers labeled XMM0-XMM1, although this also is not required. The 512-bit registers ZMM0 through ZMM31 are operable to hold 512-bit packed data, 256-bit packed data, or 128-bit packed data. The 256-bit registers YMM0-YMM15 are operable to hold 256-bit packed data, or 128-bit packed data. The 128-bit registers XMM0-XMM1 are operable to hold 128-bit packed data. Each of the registers may be used to store either packed floating-point data or packed integer data. Different data element sizes are supported including at least 8-bit byte data, 16-bit word data, 32-bit doubleword or single precision floating point data, and 64-bit quadword or double precision floating point data. Alternate embodiments of packed data registers may include different numbers of registers, different sizes of registers, and may or may not alias larger registers on smaller registers.

An instruction set includes one or more instruction formats. A given instruction format defines various fields (number of bits, location of bits) to specify, among other things, the operation to be performed (opcode) and the operand(s) on which that operation is to be performed. Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to the Advanced Vector Extensions (AVX) (AVX1 and AVX2) and using the Vector Extensions (VEX) coding scheme, has been, has been released and/or published (e.g., see Intel® 64 and IA-32 Architectures Software Developers Manual, October 2011; and see Intel® Advanced Vector Extensions Programming Reference, June 2011).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### VEX Instruction Format

VEX encoding allows instructions to have more than two operands, and allows SIMD vector registers to be longer than 128 bits. The use of a VEX prefix provides for three-operand (or more) syntax. For example, previous two-operand instructions performed operations such as A=A+B, which overwrites a source operand. The use of a VEX prefix enables operands to perform nondestructive operations such as A=B+C.

FIG. 11A illustrates an exemplary AVX instruction format including a VEX prefix 1102, real opcode field 1130, Mod R/M byte 1140, SIB byte 1150, displacement field 1162, and IMM8 1172. FIG. 11B illustrates which fields from FIG. 11A make up a full opcode field 1174 and a base operation field 1142. FIG. 11C illustrates which fields from FIG. 11A make up a register index field 1144.

VEX Prefix (Bytes 0-2) 1102 is encoded in a three-byte form. The first byte is the Format Field 1140 (VEX Byte 0, bits [7:0]), which contains an explicit C4 byte value (the unique value used for distinguishing the C4 instruction format). The second-third bytes (VEX Bytes 1-2) include a number of bit fields providing specific capability. Specifically, REX field 1105 (VEX Byte 1, bits [7-5]) consists of a VEX.R bit field (VEX Byte 1, bit [7]-R), VEX.X bit field (VEX byte 1, bit [6]-X), and VEX.B bit field (VEX byte 1, bit[5]-B). Other fields of the instructions encode the lower three bits of the register indexes as is known in the art (nr, xxx, and bbb), so that Rrrr, Xxxx, and Bbbb may be formed by adding VEX.R, VEX.X, and VEX.B. Opcode map field 1115 (VEX byte 1, bits [4:0]-mmmmm) includes content to encode an implied leading opcode byte. W Field 1164 (VEX byte 2, bit [7]-W)—is represented by the notation VEX.W, and provides different functions depending on the instruction. The role of VEX.vvvv 1120 (VEX Byte 2, bits [6:3]-vvvv) may include the following: 1) VEX.vvvv encodes the first source register operand, specified in inverted (1s complement) form and is valid for instructions with 2 or more source operands; 2) VEX.vvvv encodes the destination register operand, specified in 1s complement form for certain vector shifts; or 3) VEX.vvvv does not encode any operand, the field is reserved and should contain 1111b. If VEX.L 1168 Size field (VEX byte 2, bit [2]-L)=0, it indicates 128 bit vector; if VEX.L=1, it indicates 256 bit vector. Prefix encoding field 1125 (VEX byte 2, bits [1:0]-pp) provides additional bits for the base operation field.

Real Opcode Field 1130 (Byte 3) is also known as the opcode byte. Part of the opcode is specified in this field.

MOD R/M Field 1140 (Byte 4) includes MOD field 1142 (bits [7-6]), Reg field 1144 (bits [5-3]), and R/M field 1146 (bits [2-0]). The role of Reg field 1144 may include the following: encoding either the destination register operand or a source register operand (the rrr of Rrrr), or be treated as an opcode extension and not used to encode any instruction operand. The role of R/M field 1146 may include the following: encoding the instruction operand that references a memory address, or encoding either the destination register operand or a source register operand.

Scale, Index, Base (SIB)—The content of Scale field 1150 (Byte 5) includes SS1152 (bits [7-6]), which is used for memory address generation. The contents of SIB.xxx 1154 (bits [5-3]) and SIB.bbb 1156 (bits [2-0]) have been previously referred to with regard to the register indexes Xxxx and Bbbb.

The Displacement Field 1162 and the immediate field (IMM8) 1172 contain address data.

### Generic Vector Friendly Instruction Format

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

FIGS. 12A-12B are block diagrams illustrating a generic vector friendly instruction format and instruction templates thereof according to embodiments of the invention. FIG. 12A is a block diagram illustrating a generic vector friendly instruction format and class A instruction templates thereof according to embodiments of the invention; while FIG. 12B is a block diagram illustrating the generic vector friendly instruction format and class B instruction templates thereof according to embodiments of the invention. Specifically, a generic vector friendly instruction format 1200 for which are defined class A and class B instruction templates, both of which include no memory access 1205 instruction templates and memory access 1220 instruction templates. The term generic in the context of the vector friendly instruction format refers to the instruction format not being tied to any specific instruction set.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 12A include: 1) within the no memory access 1205 instruction templates there is shown a no memory access, full round control type operation 1210 instruction template and a no memory access, data transform type operation 1215 instruction template; and 2) within the memory access 1220 instruction templates there is shown a memory access, temporal 1225 instruction template and a memory access, non-temporal 1230 instruction template. The class B instruction templates in FIG. 12B include: 1) within the no memory access 1205 instruction templates there is shown a no memory access, write mask control, partial round control type operation 1212 instruction template and a no memory access, write mask control, vsize type operation 1217 instruction template; and 2) within the memory access 1220 instruction templates there is shown a memory access, write mask control 1227 instruction template.

The generic vector friendly instruction format 1200 includes the following fields listed below in the order illustrated in FIGS. 12A-12B.

Format field 1240—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 1242—its content distinguishes different base operations.

Register index field 1244—its content, directly or through address generation, specifies the locations of the source and destination operands, be they in registers or in memory. These include a sufficient number of bits to select N registers from a P×Q (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 1246—its content distinguishes occurrences of instructions in the generic vector instruction format that specify memory access from those that do not; that is, between no memory access 1205 instruction templates and memory access 1220 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 1250—its content distinguishes which one of a variety of different operations to be performed in addition to the base operation. This field is context specific. In one embodiment of the invention, this field is divided into a class field 1268, an alpha field 1252, and a beta field 1254. The augmentation operation field 1250 allows common groups of operations to be performed in a single instruction rather than 2, 3, or 4 instructions.

Scale field 1260—its content allows for the scaling of the index field's content for memory address generation (e.g., for address generation that uses 2^{scale}*index+base).

Displacement Field 1262A—its content is used as part of memory address generation (e.g., for address generation that uses 2^{scale}*index+base+displacement).

Displacement Factor Field 1262B (note that the juxtaposition of displacement field 1262A directly over displacement factor field 1262B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 1274 (described later herein) and the data manipulation field 1254C. The displacement field 1262A and the displacement factor field 1262B are optional in the sense that they are not used for the no memory access 1205 instruction templates and/or different embodiments may implement only one or none of the two.

Data element width field 1264—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 1270—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 1270 allows for partial vector operations, including loads, stores, arithmetic, logical, etc. While embodiments of the invention are described in which the write mask field's 1270 content selects one of a number of write mask registers that contains the write mask to be used (and thus the write mask field's 1270 content indirectly identifies that masking to be performed), alternative embodiments instead or additional allow the mask write field's 1270 content to directly specify the masking to be performed.

Immediate field 1272—its content allows for the specification of an immediate. This field is optional in the sense that is it not present in an implementation of the generic vector friendly format that does not support immediate and it is not present in instructions that do not use an immediate.

Class field 1268—its content distinguishes between different classes of instructions. With reference to FIGS. 12A-B, the contents of this field select between class A and class B instructions. In FIGS. 12A-B, rounded corner squares are used to indicate a specific value is present in a field (e.g., class A 1268A and class B 1268B for the class field 1268 respectively in FIGS. 12A-B).

### Instruction Templates of Class A

In the case of the non-memory access 1205 instruction templates of class A, the alpha field 1252 is interpreted as an RS field 1252A, whose content distinguishes which one of the different augmentation operation types are to be performed (e.g., round 1252A.1 and data transform 1252A.2 are respectively specified for the no memory access, round type operation 1210 and the no memory access, data transform type operation 1215 instruction templates), while the beta field 1254 distinguishes which of the operations of the specified type is to be performed. In the no memory access 1205 instruction templates, the scale field 1260, the displacement field 1262A, and the displacement scale filed 1262B are not present.

No-Memory Access Instruction Templates—Full Round Control Type Operation

In the no memory access full round control type operation 1210 instruction template, the beta field 1254 is interpreted as a round control field 1254A, whose content(s) provide static rounding. While in the described embodiments of the invention the round control field 1254A includes a suppress all floating point exceptions (SAE) field 1256 and a round operation control field 1258, alternative embodiments may support may encode both these concepts into the same field or only have one or the other of these concepts/fields (e.g., may have only the round operation control field 1258).

SAE field 1256—its content distinguishes whether or not to disable the exception event reporting; when the SAE field's 1256 content indicates suppression is enabled, a given instruction does not report any kind of floating-point exception flag and does not raise any floating point exception handler.

Round operation control field 1258—its content distinguishes which one of a group of rounding operations to perform (e.g., Round-up, Round-down, Round-towards-zero and Round-to-nearest). Thus, the round operation control field 1258 allows for the changing of the rounding mode on a per instruction basis. In one embodiment of the invention where a processor includes a control register for specifying rounding modes, the round operation control field's 1250 content overrides that register value.

No Memory Access Instruction Templates—Data Transform Type Operation

In the no memory access data transform type operation 1215 instruction template, the beta field 1254 is interpreted as a data transform field 1254B, whose content distinguishes which one of a number of data transforms is to be performed (e.g., no data transform, swizzle, broadcast).

In the case of a memory access 1220 instruction template of class A, the alpha field 1252 is interpreted as an eviction hint field 1252B, whose content distinguishes which one of the eviction hints is to be used (in FIG. 12A, temporal 1252B.1 and non-temporal 1252B.2 are respectively specified for the memory access, temporal 1225 instruction template and the memory access, non-temporal 1230 instruction template), while the beta field 1254 is interpreted as a data manipulation field 1254C, whose content distinguishes which one of a number of data manipulation operations (also known as primitives) is to be performed (e.g., no manipulation; broadcast; up conversion of a source; and down conversion of a destination). The memory access 1220 instruction templates include the scale field 1260, and optionally the displacement field 1262A or the displacement scale field 1262B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

Memory Access Instruction Templates—Temporal

Temporal data is data likely to be reused soon enough to benefit from caching. This is, however, a hint, and different processors may implement it in different ways, including ignoring the hint entirely.

Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 1252 is interpreted as a write mask control (Z) field 1252C, whose content distinguishes whether the write masking controlled by the write mask field 1270 should be a merging or a zeroing.

In the case of the non-memory access 1205 instruction templates of class B, part of the beta field 1254 is interpreted as an RL field 1257A, whose content distinguishes which one of the different augmentation operation types are to be performed (e.g., round 1257A.1 and vector length (VSIZE) 1257A.2 are respectively specified for the no memory access, write mask control, partial round control type operation 1212 instruction template and the no memory access, write mask control, VSIZE type operation 1217 instruction template), while the rest of the beta field 1254 distinguishes which of the operations of the specified type is to be performed. In the no memory access 1205 instruction templates, the scale field 1260, the displacement field 1262A, and the displacement scale filed 1262B are not present.

In the no memory access, write mask control, partial round control type operation 1210 instruction template, the rest of the beta field 1254 is interpreted as a round operation field 1259A and exception event reporting is disabled (a given instruction does not report any kind of floating-point exception flag and does not raise any floating point exception handler).

Round operation control field 1259A—just as round operation control field 1258, its content distinguishes which one of a group of rounding operations to perform (e.g., Round-up, Round-down, Round-towards-zero and Round-to-nearest). Thus, the round operation control field 1259A allows for the changing of the rounding mode on a per instruction basis. In one embodiment of the invention where a processor includes a control register for specifying rounding modes, the round operation control field's 1250 content overrides that register value.

In the no memory access, write mask control, VSIZE type operation 1217 instruction template, the rest of the beta field 1254 is interpreted as a vector length field 1259B, whose content distinguishes which one of a number of data vector lengths is to be performed on (e.g., 128, 256, or 512 byte).

In the case of a memory access 1220 instruction template of class B, part of the beta field 1254 is interpreted as a broadcast field 1257B, whose content distinguishes whether or not the broadcast type data manipulation operation is to be performed, while the rest of the beta field 1254 is interpreted the vector length field 1259B. The memory access 1220 instruction templates include the scale field 1260, and optionally the displacement field 1262A or the displacement scale field 1262B.

With regard to the generic vector friendly instruction format 1200, a full opcode field 1274 is shown including the format field 1240, the base operation field 1242, and the data element width field 1264. While one embodiment is shown where the full opcode field 1274 includes all of these fields, the full opcode field 1274 includes less than all of these fields in embodiments that do not support all of them. The full opcode field 1274 provides the operation code (opcode).

The augmentation operation field 1250, the data element width field 1264, and the write mask field 1270 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the invention, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the invention). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the invention. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

FIG. 13A is a block diagram illustrating an exemplary specific vector friendly instruction format according to embodiments of the invention. FIG. 13A shows a specific vector friendly instruction format 1300 that is specific in the sense that it specifies the location, size, interpretation, and order of the fields, as well as values for some of those fields. The specific vector friendly instruction format 1300 may be used to extend the x86 instruction set, and thus some of the fields are similar or the same as those used in the existing x86 instruction set and extension thereof (e.g., AVX). This format remains consistent with the prefix encoding field, real opcode byte field, MOD RIM field, SIB field, displacement field, and immediate fields of the existing x86 instruction set with extensions. The fields from FIG. 12 into which the fields from FIG. 13A map are illustrated.

It should be understood that, although embodiments of the invention are described with reference to the specific vector friendly instruction format 1300 in the context of the generic vector friendly instruction format 1200 for illustrative purposes, the invention is not limited to the specific vector friendly instruction format 1300 except where claimed. For example, the generic vector friendly instruction format 1200 contemplates a variety of possible sizes for the various fields, while the specific vector friendly instruction format 1300 is shown as having fields of specific sizes. By way of specific example, while the data element width field 1264 is illustrated as a one bit field in the specific vector friendly instruction format 1300, the invention is not so limited (that is, the generic vector friendly instruction format 1200 contemplates other sizes of the data element width field 1264).

The generic vector friendly instruction format 1200 includes the following fields listed below in the order illustrated in FIG. 13A.

EVEX Prefix (Bytes 0-3) 1302—is encoded in a four-byte form.

Format Field 1240 (EVEX Byte 0, bits [7:0])—the first byte (EVEX Byte 0) is the format field 1240 and it contains 0x62 (the unique value used for distinguishing the vector friendly instruction format in one embodiment of the invention).

The second-fourth bytes (EVEX Bytes 1-3) include a number of bit fields providing specific capability.

REX field 1305 (EVEX Byte 1, bits [7-5])—consists of a EVEX.R bit field (EVEX Byte 1, bit [7]-R), EVEX.X bit field (EVEX byte 1, bit [6]-X), and 1257BEX byte 1, bit[5]-B). The EVEX.R, EVEX.X, and EVEX.B bit fields provide the same functionality as the corresponding VEX bit fields, and are encoded using 1s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1210—this is the first part of the REX′ field 1210 and is the EVEX.R′ bit field (EVEX Byte 1, bit [4]-R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1315 (EVEX byte 1, bits [3:0]-mmmm)—its content encodes an implied leading opcode byte (0F, 0F 38, or 0F 3).

Data element width field 1264 (EVEX byte 2, bit [7]-W)—is represented by the notation EVEX.W. EVEX.W is used to define the granularity (size) of the datatype (either 32-bit data elements or 64-bit data elements).

EVEX.vvvv 1320 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 1320 encodes the 4 low-order bits of the first source register specifier stored in inverted (1s complement) form. Depending on the instruction, an extra different EVEX bit field is used to extend the specifier size to 32 registers.

EVEX.0 1268 Class field (EVEX byte 2, bit [2]-U)—If EVEX.0=0, it indicates class A or EVEX.U0; if EVEX.U=1, it indicates class B or EVEX.U1.

Prefix encoding field 1325 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1252 (EVEX byte 3, bit [7]-EH; also known as EVEX.EH, EVEX.rs, EVEX.RL, EVEX.write mask control, and EVEX.N; also illustrated with a)—as previously described, this field is context specific.

Beta field 1254 (EVEX byte 3, bits [6:4]-SSS, also known as EVEX.s₂₋₀, EVEX.r₂₋₀, EVEX.rr1, EVEX.LL0, EVEX.LLB; also illustrated with βββ—as previously described, this field is context specific.

REX′ field 1210—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 1270 (EVEX byte 3, bits [2:0]-kkk)—its content specifies the index of a register in the write mask registers as previously described. In one embodiment of the invention, the specific value EVEX kkk=000 has a special behavior implying no write mask is used for the particular instruction (this may be implemented in a variety of ways including the use of a write mask hardwired to all ones or hardware that bypasses the masking hardware).

Real Opcode Field 1330 (Byte 4) is also known as the opcode byte. Part of the opcode is specified in this field.

MOD R/M Field 1340 (Byte 5) includes MOD field 1342, Reg field 1344, and R/M field 1346. As previously described, the MOD field's 1342 content distinguishes between memory access and non-memory access operations. The role of Reg field 1344 can be summarized to two situations: encoding either the destination register operand or a source register operand, or be treated as an opcode extension and not used to encode any instruction operand. The role of R/M field 1346 may include the following: encoding the instruction operand that references a memory address, or encoding either the destination register operand or a source register operand.

Scale, Index, Base (SIB) Byte (Byte 6)—As previously described, the scale field's 1250 content is used for memory address generation. SIB.xxx 1354 and SIB.bbb 1356—the contents of these fields have been previously referred to with regard to the register indexes Xxxx and Bbbb.

Displacement field 1262A (Bytes 7-10)—when MOD field 1342 contains 10, bytes 7-10 are the displacement field 1262A, and it works the same as the legacy 32-bit displacement (disp32) and works at byte granularity.

Displacement factor field 1262B (Byte 7)—when MOD field 1342 contains 01, byte 7 is the displacement factor field 1262B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1262B is a reinterpretation of disp8; when using displacement factor field 1262B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1262B substitutes the legacy x86 instruction set 8-bit displacement. Thus, the displacement factor field 1262B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate field 1272 operates as previously described.

### Full Opcode Field

FIG. 13B is a block diagram illustrating the fields of the specific vector friendly instruction format 1300 that make up the full opcode field 1274 according to one embodiment of the invention. Specifically, the full opcode field 1274 includes the format field 1240, the base operation field 1242, and the data element width (W) field 1264. The base operation field 1242 includes the prefix encoding field 1325, the opcode map field 1315, and the real opcode field 1330.

### Register Index Field

FIG. 13C is a block diagram illustrating the fields of the specific vector friendly instruction format 1300 that make up the register index field 1244 according to one embodiment of the invention. Specifically, the register index field 1244 includes the REX field 1305, the REX′ field 1310, the MODR/M.reg field 1344, the MODR/M.r/m field 1346, the VVVV field 1320, xxx field 1354, and the bbb field 1356.

### Augmentation Operation Field

FIG. 13D is a block diagram illustrating the fields of the specific vector friendly instruction format 1300 that make up the augmentation operation field 1250 according to one embodiment of the invention. When the class (U) field 1268 contains 0, it signifies EVEX.U0 (class A 1268A); when it contains 1, it signifies EVEX.U1 (class B 1268B). When U=0 and the MOD field 1342 contains 11 (signifying a no memory access operation), the alpha field 1252 (EVEX byte 3, bit [7]-EH) is interpreted as the rs field 1252A. When the rs field 1252A contains a 1 (round 1252A.1), the beta field 1254 (EVEX byte 3, bits [6:4]-SSS) is interpreted as the round control field 1254A. The round control field 1254A includes a one bit SAE field 1256 and a two bit round operation field 1258. When the rs field 1252A contains a 0 (data transform 1252A.2), the beta field 1254 (EVEX byte 3, bits [6:4]-SSS) is interpreted as a three bit data transform field 1254B. When U=0 and the MOD field 1342 contains 00, 01, or 10 (signifying a memory access operation), the alpha field 1252 (EVEX byte 3, bit [7]-EH) is interpreted as the eviction hint (EH) field 1252B and the beta field 1254 (EVEX byte 3, bits [6:4]-SSS) is interpreted as a three bit data manipulation field 1254C.

When U=1, the alpha field 1252 (EVEX byte 3, bit [7]-EH) is interpreted as the write mask control (Z) field 1252C. When U=1 and the MOD field 1342 contains 11 (signifying a no memory access operation), part of the beta field 1254 (EVEX byte 3, bit [4]-S₀) is interpreted as the RL field 1257A; when it contains a 1 (round 1257A.1) the rest of the beta field 1254 (EVEX byte 3, bit [6-5]-S₂₋₁) is interpreted as the round operation field 1259A, while when the RL field 1257A contains a 0 (VSIZE 1257.A2) the rest of the beta field 1254 (EVEX byte 3, bit [6-5]-S₂₋₁) is interpreted as the vector length field 1259B (EVEX byte 3, bit [6-5]-L₁₋₀). When U=1 and the MOD field 1342 contains 00, 01, or 10 (signifying a memory access operation), the beta field 1254 (EVEX byte 3, bits [6:4]-SSS) is interpreted as the vector length field 1259B (EVEX byte 3, bit [6-5]-L₁₋₀) and the broadcast field 1257B (EVEX byte 3, bit [4]-B).

### Exemplary Register Architecture

FIG. 14 is a block diagram of a register architecture 1400 according to one embodiment of the invention. In the embodiment illustrated, there are 32 vector registers 1410 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1300 operates on these overlaid register file as illustrated in the below tables.

| Adjustable Vector | | | |
|---|---|---|---|
| Length | Class | Operations | Registers |
| Instruction Templates | A (FIG. | 1210, 1215, | zmm registers (the vector |
| that do not include the | 12A; | 1225, 1230 | length is 64 byte) |
| vector length field | U = 0) | | |
| 1259B | B (FIG. | 1212 | zmm registers (the vector |
| | 12B; | | length is 64 byte) |
| | U = 1) | | |
| Instruction templates | B (FIG. | 1217, 1227 | zmm, ymm, or xmm |
| that do include the | 12B; | | registers (the vector |
| vector length field | U = 1) | | length is 64 byte, |
| 1259B | | | 32 byte, or 16 byte) |
| | | | depending on the vector |
| | | | length field 1259B |

In other words, the vector length field 1259B selects between a maximum length and one or more other shorter lengths, where each such shorter length is half the length of the preceding length; and instructions templates without the vector length field 1259B operate on the maximum vector length. Further, in one embodiment, the class B instruction templates of the specific vector friendly instruction format 1300 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1415—in the embodiment illustrated, there are 8 write mask registers (k0 through k7), each 64 bits in size. In an alternate embodiment, the write mask registers 1415 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 1425—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1445, on which is aliased the MMX packed integer flat register file 1450—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

FIG. 15A is a block diagram illustrating both an exemplary in-order pipeline and an exemplary register renaming, out-of-order issue/execution pipeline according to embodiments of the invention. FIG. 15B is a block diagram illustrating both an exemplary embodiment of an in-order architecture core and an exemplary register renaming, out-of-order issue/execution architecture core to be included in a processor according to embodiments of the invention. The solid lined boxes in FIGS. 15A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 15A, a processor pipeline 1500 includes a fetch stage 1502, a length decode stage 1504, a decode stage 1506, an allocation stage 1508, a renaming stage 1510, a scheduling (also known as a dispatch or issue) stage 1512, a register read/memory read stage 1514, an execute stage 1516, a write back/memory write stage 1518, an exception handling stage 1522, and a commit stage 1524.

FIG. 15B shows processor core 1590 including a front end unit 1530 coupled to an execution engine unit 1550, and both are coupled to a memory unit 1570. The core 1590 may be a reduced instruction set computing (RISC) core, a complex instruction set computing (CISC) core, a very long instruction word (VLIW) core, or a hybrid or alternative core type. As yet another option, the core 1590 may be a special-purpose core, such as, for example, a network or communication core, compression engine, coprocessor core, general purpose computing graphics processing unit (GPGPU) core, graphics core, or the like.

The front end unit 1530 includes a branch prediction unit 1532 coupled to an instruction cache unit 1534, which is coupled to an instruction translation lookaside buffer (TLB) 1536, which is coupled to an instruction fetch unit 1538, which is coupled to a decode unit 1540. The decode unit 1540 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1540 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1590 includes a microcode ROM or other medium that stores microcode for certain macroinstructions (e.g., in decode unit 1540 or otherwise within the front end unit 1530). The decode unit 1540 is coupled to a rename/allocator unit 1552 in the execution engine unit 1550.

The execution engine unit 1550 includes the rename/allocator unit 1552 coupled to a retirement unit 1554 and a set of one or more scheduler unit(s) 1556. The scheduler unit(s) 1556 represents any number of different schedulers, including reservations stations, central instruction window, etc. The scheduler unit(s) 1556 is coupled to the physical register file(s) unit(s) 1558. Each of the physical register file(s) units 1558 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1558 comprises a vector registers unit, a write mask registers unit, and a scalar registers unit. These register units may provide architectural vector registers, vector mask registers, and general purpose registers. The physical register file(s) unit(s) 1558 is overlapped by the retirement unit 1554 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1554 and the physical register file(s) unit(s) 1558 are coupled to the execution cluster(s) 1560. The execution cluster(s) 1560 includes a set of one or more execution units 1562 and a set of one or more memory access units 1564. The execution units 1562 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1556, physical register file(s) unit(s) 1558, and execution cluster(s) 1560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1564). It should also be understood that where separate pipelines are used, one or more of these pipelines may be out-of-order issue/execution and the rest in-order.

The set of memory access units 1564 is coupled to the memory unit 1570, which includes a data TLB unit 1572 coupled to a data cache unit 1574 coupled to a level 2 (L2) cache unit 1576. In one exemplary embodiment, the memory access units 1564 may include a load unit, a store address unit, and a store data unit, each of which is coupled to the data TLB unit 1572 in the memory unit 1570. The instruction cache unit 1534 is further coupled to a level 2 (L2) cache unit 1576 in the memory unit 1570. The L2 cache unit 1576 is coupled to one or more other levels of cache and eventually to a main memory.

By way of example, the exemplary register renaming, out-of-order issue/execution core architecture may implement the pipeline 1500 as follows: 1) the instruction fetch 1538 performs the fetch and length decoding stages 1502 and 1504; 2) the decode unit 1540 performs the decode stage 1506; 3) the rename/allocator unit 1552 performs the allocation stage 1508 and renaming stage 1510; 4) the scheduler unit(s) 1556 performs the schedule stage 1512; 5) the physical register file(s) unit(s) 1558 and the memory unit 1570 perform the register read/memory read stage 1514; the execution cluster 1560 perform the execute stage 1516; 6) the memory unit 1570 and the physical register file(s) unit(s) 1558 perform the write back/memory write stage 1518; 7) various units may be involved in the exception handling stage 1522; and 8) the retirement unit 1554 and the physical register file(s) unit(s) 1558 perform the commit stage 1524.

The core 1590 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1590 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1534/1574 and a shared L2 cache unit 1576, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

FIGS. 16A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 16A is a block diagram of a single processor core, along with its connection to the on-die interconnect network 1602 and with its local subset of the Level 2 (L2) cache 1604, according to embodiments of the invention. In one embodiment, an instruction decoder 1600 supports the x86 instruction set with a packed data instruction set extension. An L1 cache 1606 allows low-latency accesses to cache memory into the scalar and vector units. While in one embodiment (to simplify the design), a scalar unit 1608 and a vector unit 1610 use separate register sets (respectively, scalar registers 1612 and vector registers 1614) and data transferred between them is written to memory and then read back in from a level 1 (L1) cache 1606, alternative embodiments of the invention may use a different approach (e.g., use a single register set or include a communication path that allow data to be transferred between the two register files without being written and read back).

The local subset of the L2 cache 1604 is part of a global L2 cache that is divided into separate local subsets, one per processor core. Each processor core has a direct access path to its own local subset of the L2 cache 1604. Data read by a processor core is stored in its L2 cache subset 1604 and can be accessed quickly, in parallel with other processor cores accessing their own local L2 cache subsets. Data written by a processor core is stored in its own L2 cache subset 1604 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 16B is an expanded view of part of the processor core in FIG. 16A according to embodiments of the invention. FIG. 16B includes an L1 data cache 1606A part of the L1 cache 1604, as well as more detail regarding the vector unit 1610 and the vector registers 1614. Specifically, the vector unit 1610 is a 16-wide vector processing unit (VPU) (see the 16-wide ALU 1628), which executes one or more of integer, single-precision float, and double-precision float instructions. The VPU supports swizzling the register inputs with swizzle unit 1620, numeric conversion with numeric convert units 1622A-B, and replication with replication unit 1624 on the memory input. Write mask registers 1626 allow predicating resulting vector writes.

Processor with Integrated Memory Controller and Graphics

FIG. 17 is a block diagram of a processor 1700 that may have more than one core, may have an integrated memory controller, and may have integrated graphics according to embodiments of the invention. The solid lined boxes in FIG. 17 illustrate a processor 1700 with a single core 1702A, a system agent 1710, a set of one or more bus controller units 1716, while the optional addition of the dashed lined boxes illustrates an alternative processor 1700 with multiple cores 1702A-N, a set of one or more integrated memory controller unit(s) 1714 in the system agent unit 1710, and special purpose logic 1708.

Thus, different implementations of the processor 1700 may include: 1) a CPU with the special purpose logic 1708 being integrated graphics and/or scientific (throughput) logic (which may include one or more cores), and the cores 1702A-N being one or more general purpose cores (e.g., general purpose in-order cores, general purpose out-of-order cores, a combination of the two); 2) a coprocessor with the cores 1702A-N being a large number of special purpose cores intended primarily for graphics and/or scientific (throughput); and 3) a coprocessor with the cores 1702A-N being a large number of general purpose in-order cores. Thus, the processor 1700 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1700 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1706, and external memory (not shown) coupled to the set of integrated memory controller units 1714. The set of shared cache units 1706 may include one or more mid-level caches, such as level 2 (L2), level 3 (L3), level 4 (L4), or other levels of cache, a last level cache (LLC), and/or combinations thereof. While in one embodiment a ring based interconnect unit 1712 interconnects the integrated graphics logic 1708, the set of shared cache units 1706, and the system agent unit 1710/integrated memory controller unit(s) 1714, alternative embodiments may use any number of well-known techniques for interconnecting such units. In one embodiment, coherency is maintained between one or more cache units 1706 and cores 1702-A-N.

In some embodiments, one or more of the cores 1702A-N are capable of multi-threading. The system agent 1710 includes those components coordinating and operating cores 1702A-N. The system agent unit 1710 may include for example a power control unit (PCU) and a display unit. The PCU may be or include logic and components needed for regulating the power state of the cores 1702A-N and the integrated graphics logic 1708. The display unit is for driving one or more externally connected displays.

The cores 1702A-N may be homogenous or heterogeneous in terms of architecture instruction set; that is, two or more of the cores 1702A-N may be capable of execution the same instruction set, while others may be capable of executing only a subset of that instruction set or a different instruction set.

### Exemplary Computer Architectures

FIGS. 18-21 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 18, shown is a block diagram of a system 1800 in accordance with one embodiment of the present invention. The system 1800 may include one or more processors 1810, 1815, which are coupled to a controller hub 1820. In one embodiment the controller hub 1820 includes a graphics memory controller hub (GMCH) 1890 and an Input/Output Hub (IOH) 1850 (which may be on separate chips); the GMCH 1890 includes memory and graphics controllers to which are coupled memory 1840 and a coprocessor 1845; the IOH 1850 is couples input/output (I/O) devices 1860 to the GMCH 1890. Alternatively, one or both of the memory and graphics controllers are integrated within the processor (as described herein), the memory 1840 and the coprocessor 1845 are coupled directly to the processor 1810, and the controller hub 1820 in a single chip with the IOH 1850.

The optional nature of additional processors 1815 is denoted in FIG. 18 with broken lines. Each processor 1810, 1815 may include one or more of the processing cores described herein and may be some version of the processor 1700.

The memory 1840 may be, for example, dynamic random access memory (DRAM), phase change memory (PCM), or a combination of the two. For at least one embodiment, the controller hub 1820 communicates with the processor(s) 1810, 1815 via a multi-drop bus, such as a frontside bus (FSB), point-to-point interface such as QuickPath Interconnect (QPI), or similar connection 1895.

In one embodiment, the coprocessor 1845 is a special-purpose processor, such as, for example, a high-throughput MIC processor, a network or communication processor, compression engine, graphics processor, GPGPU, embedded processor, or the like. In one embodiment, controller hub 1820 may include an integrated graphics accelerator.

There can be a variety of differences between the physical resources 1810, 1815 in terms of a spectrum of metrics of merit including architectural, microarchitectural, thermal, power consumption characteristics, and the like.

In one embodiment, the processor 1810 executes instructions that control data processing operations of a general type. Embedded within the instructions may be coprocessor instructions. The processor 1810 recognizes these coprocessor instructions as being of a type that should be executed by the attached coprocessor 1845. Accordingly, the processor 1810 issues these coprocessor instructions (or control signals representing coprocessor instructions) on a coprocessor bus or other interconnect, to coprocessor 1845. Coprocessor(s) 1845 accept and execute the received coprocessor instructions.

Referring now to FIG. 19, shown is a block diagram of a first more specific exemplary system 1900 in accordance with an embodiment of the present invention. As shown in FIG. 19, multiprocessor system 1900 is a point-to-point interconnect system, and includes a first processor 1970 and a second processor 1980 coupled via a point-to-point interconnect 1950. Each of processors 1970 and 1980 may be some version of the processor 1700. In one embodiment of the invention, processors 1970 and 1980 are respectively processors 1810 and 1815, while coprocessor 1938 is coprocessor 1845. In another embodiment, processors 1970 and 1980 are respectively processor 1810 coprocessor 1845.

Processors 1970 and 1980 are shown including integrated memory controller (IMC) units 1972 and 1982, respectively. Processor 1970 also includes as part of its bus controller units point-to-point (P-P) interfaces 1976 and 1978; similarly, second processor 1980 includes P-P interfaces 1986 and 1988. Processors 1970, 1980 may exchange information via a point-to-point (P-P) interface 1950 using P-P interface circuits 1978, 1988. As shown in FIG. 19, IMCs 1972 and 1982 couple the processors to respective memories, namely a memory 1932 and a memory 1934, which may be portions of main memory locally attached to the respective processors.

Processors 1970, 1980 may each exchange information with a chipset 1990 via individual P-P interfaces 1952, 1954 using point to point interface circuits 1976, 1994, 1986, 1998. Chipset 1990 may optionally exchange information with the coprocessor 1938 via a high-performance interface 1939. In one embodiment, the coprocessor 1938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1990 may be coupled to a first bus 1916 via an interface 1996. In one embodiment, first bus 1916 may be a Peripheral Component Interconnect (PCI) bus, or a bus such as a PCI Express bus or another third generation I/O interconnect bus, although the scope of the present invention is not so limited.

As shown in FIG. 19, various I/O devices 1914 may be coupled to first bus 1916, along with a bus bridge 1918 which couples first bus 1916 to a second bus 1920. In one embodiment, one or more additional processor(s) 1915, such as coprocessors, high-throughput MIC processors, GPGPU's, accelerators (such as, e.g., graphics accelerators or digital signal processing (DSP) units), field programmable gate arrays, or any other processor, are coupled to first bus 1916. In one embodiment, second bus 1920 may be a low pin count (LPC) bus. Various devices may be coupled to a second bus 1920 including, for example, a keyboard and/or mouse 1922, communication devices 1927 and a storage unit 1928 such as a disk drive or other mass storage device which may include instructions/code and data 1930, in one embodiment. Further, an audio I/O 1924 may be coupled to the second bus 1920. Note that other architectures are possible. For example, instead of the point-to-point architecture of FIG. 19, a system may implement a multi-drop bus or other such architecture.

Referring now to FIG. 20, shown is a block diagram of a second more specific exemplary system 2000 in accordance with an embodiment of the present invention Like elements in FIGS. 19 and 20 bear like reference numerals, and certain aspects of FIG. 19 have been omitted from FIG. 20 in order to avoid obscuring other aspects of FIG. 20.

FIG. 20 illustrates that the processors 1970, 1980 may include integrated memory and I/O control logic (“CL”) 1972 and 1982, respectively. Thus, the CL 1972, 1982 includes integrated memory controller units and includes I/O control logic. FIG. 20 illustrates that not only are the memories 1932, 1934 coupled to the CL 1972, 1982, but also that I/O devices 2014 are also coupled to the control logic 1972, 1982. Legacy I/O devices 2015 are coupled to the chipset 1990.

Referring now to FIG. 21, shown is a block diagram of a SoC 2100 in accordance with an embodiment of the present invention. Similar elements in FIG. 17 bear like reference numerals. Also, dashed lined boxes are optional features on more advanced SoCs. In FIG. 21, an interconnect unit(s) 2102 is coupled to: an application processor 2110 which includes a set of one or more cores 202A-N and shared cache unit(s) 1706; a system agent unit 1710; a bus controller unit(s) 1716; an integrated memory controller unit(s) 1714; a set or one or more coprocessors 2120 which may include integrated graphics logic, an image processor, an audio processor, and a video processor; an static random access memory (SRAM) unit 2130; a direct memory access (DMA) unit 2132; and a display unit 2140 for coupling to one or more external displays. In one embodiment, the coprocessor(s) 2120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1930 illustrated in FIG. 19, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 22 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 22 shows a program in a high level language 2202 may be compiled using an x86 compiler 2204 to generate x86 binary code 2206 that may be natively executed by a processor with at least one x86 instruction set core 2216. The processor with at least one x86 instruction set core 2216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2204 represents a compiler that is operable to generate x86 binary code 2206 (e.g., object code) that can, with or without additional linkage processing, be executed on the processor with at least one x86 instruction set core 2216. Similarly, FIG. 22 shows the program in the high level language 2202 may be compiled using an alternative instruction set compiler 2208 to generate alternative instruction set binary code 2210 that may be natively executed by a processor without at least one x86 instruction set core 2214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2212 is used to convert the x86 binary code 2206 into code that may be natively executed by the processor without an x86 instruction set core 2214. This converted code is not likely to be the same as the alternative instruction set binary code 2210 because an instruction converter capable of this is difficult to make; however, the converted code will accomplish the general operation and be made up of instructions from the alternative instruction set. Thus, the instruction converter 2212 represents software, firmware, hardware, or a combination thereof that, through emulation, simulation or any other process, allows a processor or other electronic device that does not have an x86 instruction set processor or core to execute the x86 binary code 2206.

Components, features, and details described for any of FIGS. 4-9 may also optionally be used in any of FIGS. 1-3. The formats of FIG. 4 may be used by any of the instructions or embodiments disclosed herein. The registers of FIG. 10 may be used by any of the instructions or embodiments disclosed herein. Moreover, components, features, and details described herein for any of the apparatus may also optionally be used in any of the methods described herein, which in embodiments may be performed by and/or with such the apparatus.

### EXAMPLE EMBODIMENTS

The following examples pertain to further embodiments. Specifics in the examples may be used anywhere in one or more embodiments.

Example 1 is an apparatus to process instructions. The apparatus includes a plurality of packed data registers. The apparatus also includes an execution unit coupled with the packed data registers, the execution unit, in response to a multiple element-to-multiple element comparison instruction, which is to indicate a first source packed data that is to include a first plurality of packed data elements, a second source packed data that is to include a second plurality of packed data elements, and a destination storage location, operable to store a packed data result that is to include a plurality of packed result data elements in the destination storage location. Each of the result data elements to correspond to a different one of the data elements of the second source packed data, each of the result data elements to include a multiple bit comparison mask that is to include a different comparison mask bit for each different corresponding data element of the first source packed data compared with the data element of the second source packed data that corresponds to the result data element, each comparison mask bit to indicate a result of a corresponding comparison.

Example 2 includes the subject matter of Example 1 and optionally wherein the execution unit, in response to the instruction, is to store the packed data result that is to indicate results of comparisons of all data elements of the first source packed data with all data elements of the second source packed data.

Example 3 includes the subject matter of Example 1 and optionally wherein the execution unit, in response to the instruction, is to store a multiple bit comparison mask in a given packed result data element that is to indicate which of the packed data elements of the first source packed data equal a packed data element of the second source that corresponds to the given packed result data element.

Example 4 includes the subject matter of any of Examples 1-3 and optionally wherein the first source packed data is to have N packed data elements and the second source packed data is to have N packed data elements, and wherein the execution unit, in response to the instruction, is to store the packed data result that is to include N, N-bit packed result data elements.

Example 5 includes the subject matter of Example 4 and optionally wherein the first source packed data is to have eight 8-bit packed data elements and the second source packed data is to have eight 8-bit packed data elements, and wherein the execution unit, in response to the instruction, is to store the packed data result that is to include eight 8-bit packed result data elements.

Example 6 includes the subject matter of Example 4 and optionally wherein the first source packed data is to have sixteen 8-bit packed data elements and the second source packed data is to have sixteen 8-bit packed data elements, and wherein the execution unit, in response to the instruction, is to store the packed data result that is to include sixteen 16-bit packed result data elements.

Example 7 includes the subject matter of Example 4 and optionally wherein the first source packed data is to have thirty-two 8-bit packed data elements and the second source packed data is to have thirty-two 8-bit packed data elements, and wherein the execution unit, in response to the instruction, is to store the packed data result that is to include thirty-two 32-bit packed result data elements.

Example 8 includes the subject matter of any of Examples 1-3 and optionally wherein the first source packed data is to have N packed data elements and the second source packed data is to have N packed data elements, wherein the instruction is to indicate an offset, wherein the execution unit, in response to the instruction, is to store the packed data result that is to include N/2, N-bit packed result data elements, and wherein a least significant one of the N/2, N-bit packed result data elements to correspond to a packed data element of the second source that is to be indicated by the offset.

Example 9 includes the subject matter of any of Examples 1-3 and optionally wherein the execution unit, in response to the instruction, is to store a packed result data element that is to include a multiple bit comparison mask in which each mask bit is to have a value of binary one to indicate that the corresponding packed data element of the first source packed data equals a packed data element of the second source that corresponds to the packed result data element, and a value of binary zero to indicate that the corresponding packed data element of the first source packed data does not equal the packed data element of the second source that corresponds to the packed result data element.

Example 10 includes the subject matter of any of Examples 1-3 and optionally wherein the execution unit, in response to the instruction, is to store multiple bit comparison masks that are to indicate the results of the comparisons of only a subset of data elements of one of the first and second source packed data with data elements of another one of the first and second source packed data.

Example 11 includes the subject matter of any of Examples 1-3 and optionally wherein the instruction is to indicate a subset of data elements of one of the first and second source packed data that are to be compared.

Example 12 includes the subject matter of any of Examples 1-3 and optionally wherein the instruction is to implicitly indicate the destination storage location.

Example 13 is a method of processing an instruction. The method includes receiving a multiple element-to-multiple element comparison instruction, the multiple element-to-multiple element comparison instruction indicating a first source packed data having a first plurality of packed data elements, a second source packed data having a second plurality of packed data elements, and a destination storage location. The method also includes storing a packed data result including a plurality of packed result data elements in the destination storage location in response to the multiple element-to-multiple element comparison instruction. Each of the packed result data elements corresponding to a different one of the packed data elements of the second source packed data, each of the packed result data elements including a multiple bit comparison mask that includes a different mask bit for each different corresponding packed data element of the first source packed data, which has been compared with the packed data element of the second source that corresponds to the packed result data element, to indicate a result of a comparison.

Example 14 includes the subject matter of Example 13 and optionally wherein storing comprises storing a packed data result that indicates results of comparing all data elements of the first source packed data with all data elements of the second source packed data.

Example 15 includes the subject matter of Example 13 and optionally wherein receiving comprises receiving the instruction indicating the first source packed data having N packed data elements and the second source packed data having N packed data elements, and wherein storing comprises storing the packed data result including N, N-bit packed result data elements.

Example 16 includes the subject matter of Example 15 and optionally wherein receiving comprises receiving the instruction indicating the first source packed data having sixteen 8-bit packed data elements and the second source packed data having sixteen 8-bit packed data elements, and wherein storing comprises storing the packed data result including sixteen 16-bit packed result data elements.

Example 17 includes the subject matter of Example 13 and optionally wherein receiving comprises receiving the instruction indicating the first source packed data having N packed data elements, indicating the second source packed data having N packed data elements, and indicating an offset, and wherein storing comprises storing the packed data result including N/2, N-bit packed result data elements, a least significant one of the N/2, N-bit packed result data elements corresponding to a packed data element of the second source indicated by the offset.

Example 18 includes the subject matter of any of Example 13 and optionally wherein receiving comprises receiving the instruction indicating the first source packed data having N packed data elements, indicating the second source packed data having N packed data elements, and indicating an offset, and wherein storing comprises storing the packed data result including N/2, N-bit packed result data elements, a least significant one of the N/2, N-bit packed result data elements corresponding to a packed data element of the second source indicated by the offset.

Example 19 includes the subject matter of any of Example 13 and optionally wherein receiving comprises receiving the instruction indicating the first source packed data representing a first biological sequence and indicating the second source packed data representing a second biological sequence.

Example 20 is a system to process instructions. The system includes an interconnect. The system also includes a processor coupled with the interconnect. The system also includes a dynamic random access memory (DRAM) coupled with the interconnect, the DRAM storing a multiple element-to-multiple element comparison instruction, the instruction to indicate a first source packed data that is to include a first plurality of packed data elements, a second source packed data that is to include a second plurality of packed data elements and a destination storage location. The instruction if executed by the processor operable to cause the processor to perform operations including storing a packed data result that is to include a plurality of packed result data elements in the destination storage location, each of the packed result data elements to correspond to a different one of the packed data elements of the second source packed data. Each of the packed result data elements to include a multiple bit comparison mask that is to indicate results of comparisons of multiple packed data elements of the first source packed data with the packed data element of the second source that is to correspond to the packed result data element.

Example 21 includes the subject matter of Example 20 and optionally wherein the instruction if executed by the processor is operable to cause the processor to store the packed data result that is to indicate results of comparisons of all packed data elements of the first source packed data with all data elements of the second source packed data.

Example 22 includes the subject matter of any of Examples 20-21 and optionally wherein the instruction is to indicate the first source packed data which is to have N packed data elements and the second source packed data which is to have N packed data elements, and wherein the instruction if executed by the processor is operable to cause the processor to store the packed data result that is to include N, N-bit packed result data elements.

Example 23 is an article of manufacture to provide instructions. The article of manufacture includes a non-transitory machine-readable storage medium storing an instruction. The article of manufacture also includes the instruction to indicate a first source packed data that is to have a first plurality of packed data elements, a second source packed data that is to have a second plurality of packed data elements, and a destination storage location, and the instruction if executed by a machine operable to cause the machine to perform operations including storing a packed data result that is to include a plurality of packed result data elements in the destination storage location, each of the packed result data elements to correspond to a different one of the packed data elements of the second source packed data, each of the packed result data elements to include a multiple bit comparison mask, each multiple bit comparison mask to indicate results of comparisons of multiple packed data elements of the first source packed data with the packed data element of the second source that is to correspond to the packed result data element having the multiple bit comparison mask.

Example 24 includes the subject matter of Example 23 and optionally wherein the instruction is to indicate the first source packed data that is to have N packed data elements and the second source packed data that is to have N packed data elements, and wherein the instruction if executed by the machine is operable to cause the machine to store the packed data result that is to include N, N-bit packed result data elements.

Example 25 includes the subject matter of Examples 23-24 and optionally wherein the non-transitory machine-readable storage medium comprises one of a non-volatile memory, DRAM, and a CD-ROM, and wherein the instruction if executed by the machine is operable to cause the machine to store the packed data result that is to indicate which among all packed data elements of the first source packed data are equal to which among all data elements of the second source packed data.

Example 26 includes an apparatus to perform the method of any of Examples 13-19.

Example 27 includes an apparatus comprising means for performing the method of any of Examples 13-19.

Example 28 includes an apparatus comprising decoding means and execution means for performing the method of any of Examples 13-19.

Example 29 includes a machine-readable storage medium storing an instruction that if executed by a machine is to cause the machine to perform the method of any of Examples 13-19.

Example 30 includes an apparatus to perform a method substantially as described herein.

Example 31 includes an apparatus to execute an instruction substantially as described herein.

Example 32 includes an apparatus comprising means for performing a method substantially as described herein.

In the description and claims, the terms “coupled” and/or “connected,” along with their derivatives, have be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. For example, an execution unit may be coupled with a register or a decoder through one or more intervening components. In the figures, arrows are used to show connections and couplings.

In the description and claims, the term “logic” may have been used. As used herein, logic may include hardware, firmware, software, or various combinations thereof. Examples of logic include integrated circuitry, application specific integrated circuits, analog circuits, digital circuits, programmed logic devices, memory devices including instructions, etc. In some embodiments, hardware logic may include transistors and/or gates potentially along with other circuitry components.

In the description above, specific details have been set forth in order to provide a thorough understanding of the embodiments. However, other embodiments may be practiced without some of these specific details. The scope of the invention is not to be determined by the specific examples provided above but only by the claims below. All equivalent relationships to those illustrated in the drawings and described in the specification are encompassed within embodiments. In other instances, well-known circuits, structures, devices, and operations have been shown in block diagram form or without detail in order to avoid obscuring the understanding of the description. In some cases, where multiple components have been shown and described, they may be integrated together into a single component. Where a single component has been shown and described, in some cases this single component may be separated into two or more components.

Various operations and methods have been described. Some of the methods have been described in a relatively basic form in the flow diagrams, but operations may optionally be added to and/or removed from the methods. In addition, while the flow diagrams show a particular order of the operations according to example embodiments, that particular order is exemplary. Alternate embodiments may optionally perform the operations in different order, combine certain operations, overlap certain operations, etc.

Certain operations may be performed by hardware components, or may be embodied in machine-executable or circuit-executable instructions, that may be used to cause and/or result in a machine, circuit, or hardware component (e.g., a processor, potion of a processor, circuit, etc.) programmed with the instructions performing the operations. The operations may also optionally be performed by a combination of hardware and software. A processor, machine, circuit, or hardware may include specific or particular circuitry or other logic (e.g., hardware potentially combined with firmware and/or software) is operable to execute and/or process the instruction and store a result in response to the instruction.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operable to cause the machine to perform and/or result in the machine performing one or operations, methods, or techniques disclosed herein. The machine-readable medium may provide, for example store, one or more of the embodiments of the instructions disclosed herein.

In some embodiments, the machine-readable medium may include a tangible and/or non-transitory machine-readable storage medium. For example, the tangible and/or non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In another embodiment, the machine-readable medium may include a transitory machine-readable communication medium, for example, the electrical, optical, acoustical or other forms of propagated signals, such as carrier waves, infrared signals, digital signals, or the like.

Examples of suitable machines include, but are not limited to, general-purpose processors, special-purpose processors, instruction processing apparatus, digital logic circuits, integrated circuits, and the like. Still other examples of suitable machines include computing devices and other electronic devices that incorporate such processors, instruction processing apparatus, digital logic circuits, or integrated circuits. Examples of such computing devices and electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Reference throughout this specification to “one embodiment,” “an embodiment,” “one or more embodiments,” “some embodiments,” for example, indicates that a particular feature may be included in the practice of the invention but is not necessarily required to be. Similarly, in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects lie in less than all features of a single disclosed embodiment. Thus, the claims following the Detailed Description are hereby expressly incorporated into this Detailed Description, with each claim standing on its own as a separate embodiment of the invention.

What is claimed is:

1. An apparatus to process instructions comprising:
a plurality of packed data registers; and
an execution unit coupled with the packed data registers, the execution unit, in response to a multiple element-to-multiple element comparison instruction, which is to indicate a first source packed data that is to include a first plurality of packed data elements, a second source packed data that is to include a second plurality of packed data elements, and a destination storage location, operable to store a packed data result that is to include a plurality of packed result data elements in the destination storage location, each of the result data elements to correspond to a different one of the data elements of the second source packed data, each of the result data elements to include a multiple bit comparison mask that is to include a different comparison mask bit for each different corresponding data element of the first source packed data compared with the data element of the second source packed data that corresponds to the result data element, each comparison mask bit to indicate a result of a corresponding comparison.

2. The apparatus of claim 1, wherein the execution unit, in response to the instruction, is to store the packed data result that is to indicate results of comparisons of all data elements of the first source packed data with all data elements of the second source packed data.

3. The apparatus of claim 1, wherein the execution unit, in response to the instruction, is to store a multiple bit comparison mask in a given packed result data element that is to indicate which of the packed data elements of the first source packed data equal a packed data element of the second source that corresponds to the given packed result data element.

4. The apparatus of claim 1, wherein the first source packed data is to have N packed data elements and the second source packed data is to have N packed data elements, and wherein the execution unit, in response to the instruction, is to store the packed data result that is to include N, N-bit packed result data elements.

5. The apparatus of claim 4, wherein the first source packed data is to have eight 8-bit packed data elements and the second source packed data is to have eight 8-bit packed data elements, and wherein the execution unit, in response to the instruction, is to store the packed data result that is to include eight 8-bit packed result data elements.

6. The apparatus of claim 4, wherein the first source packed data is to have sixteen 8-bit packed data elements and the second source packed data is to have sixteen 8-bit packed data elements, and wherein the execution unit, in response to the instruction, is to store the packed data result that is to include sixteen 16-bit packed result data elements.

7. The apparatus of claim 4, wherein the first source packed data is to have thirty-two 8-bit packed data elements and the second source packed data is to have thirty-two 8-bit packed data elements, and wherein the execution unit, in response to the instruction, is to store the packed data result that is to include thirty-two 32-bit packed result data elements.

8. The apparatus of claim 1, wherein the first source packed data is to have N packed data elements and the second source packed data is to have N packed data elements, wherein the instruction is to indicate an offset, wherein the execution unit, in response to the instruction, is to store the packed data result that is to include N/2, N-bit packed result data elements, and wherein a least significant one of the N/2, N-bit packed result data elements to correspond to a packed data element of the second source that is to be indicated by the offset.

9. The apparatus of claim 1, wherein the execution unit, in response to the instruction, is to store a packed result data element that is to include a multiple bit comparison mask in which each mask bit is to have one of:
a value of binary one to indicate that the corresponding packed data element of the first source packed data equals a packed data element of the second source that corresponds to the packed result data element; and
a value of binary zero to indicate that the corresponding packed data element of the first source packed data does not equal the packed data element of the second source that corresponds to the packed result data element.

10. The apparatus of claim 1, wherein the execution unit, in response to the instruction, is to store multiple bit comparison masks that are to indicate the results of the comparisons of only a subset of data elements of one of the first and second source packed data with data elements of another one of the first and second source packed data.

11. The apparatus of claim 1, wherein the instruction is to indicate a subset of data elements of one of the first and second source packed data that are to be compared.

12. The apparatus of claim 1, wherein the instruction is to implicitly indicate the destination storage location.

13. A method of processing an instruction comprising:
receiving a multiple element-to-multiple element comparison instruction, the multiple element-to-multiple element comparison instruction indicating a first source packed data having a first plurality of packed data elements, a second source packed data having a second plurality of packed data elements, and a destination storage location; and
storing a packed data result including a plurality of packed result data elements in the destination storage location in response to the multiple element-to-multiple element comparison instruction, each of the packed result data elements corresponding to a different one of the packed data elements of the second source packed data, each of the packed result data elements including a multiple bit comparison mask that includes a different mask bit for each different corresponding packed data element of the first source packed data, which has been compared with the packed data element of the second source that corresponds to the packed result data element, to indicate a result of a comparison.

14. The method of claim 13, wherein storing comprises storing a packed data result that indicates results of comparing all data elements of the first source packed data with all data elements of the second source packed data.

15. The method of claim 13, wherein receiving comprises receiving the instruction indicating the first source packed data having N packed data elements and the second source packed data having N packed data elements, and wherein storing comprises storing the packed data result including N, N-bit packed result data elements.

16. The method of claim 15, wherein receiving comprises receiving the instruction indicating the first source packed data having sixteen 8-bit packed data elements and the second source packed data having sixteen 8-bit packed data elements, and wherein storing comprises storing the packed data result including sixteen 16-bit packed result data elements.

17. The method of claim 13, wherein receiving comprises receiving the instruction indicating the first source packed data having N packed data elements, indicating the second source packed data having N packed data elements, and indicating an offset, and wherein storing comprises storing the packed data result including N/2, N-bit packed result data elements, a least significant one of the N/2, N-bit packed result data elements corresponding to a packed data element of the second source indicated by the offset.

18. The method of claim 13, wherein storing comprises storing multiple bit comparison masks that indicate the results of the comparisons of only a subset of data elements of one of the first and second source packed data with data elements of another of the first and second source packed data.

19. The method of claim 13, wherein receiving comprises receiving the instruction indicating the first source packed data representing a first biological sequence and indicating the second source packed data representing a second biological sequence.

20. A system to process instructions comprising:
an interconnect;
a processor coupled with the interconnect; and
a dynamic random access memory (DRAM) coupled with the interconnect, the DRAM storing a multiple element-to-multiple element comparison instruction, the instruction to indicate a first source packed data that is to include a first plurality of packed data elements, a second source packed data that is to include a second plurality of packed data elements, and a destination storage location, and the instruction if executed by the processor operable to cause the processor to perform operations comprising:
storing a packed data result that is to include a plurality of packed result data elements in the destination storage location, each of the packed result data elements to correspond to a different one of the packed data elements of the second source packed data, each of the packed result data elements to include a multiple bit comparison mask that is to indicate results of comparisons of multiple packed data elements of the first source packed data with the packed data element of the second source that is to correspond to the packed result data element.

21. The system of claim 20, wherein the instruction if executed by the processor is operable to cause the processor to store the packed data result that is to indicate results of comparisons of all packed data elements of the first source packed data with all data elements of the second source packed data.

22. The system of claim 20, wherein the instruction is to indicate the first source packed data which is to have N packed data elements and the second source packed data which is to have N packed data elements, and wherein the instruction if executed by the processor is operable to cause the processor to store the packed data result that is to include N, N-bit packed result data elements.

23. An article of manufacture to provide instructions comprising:
a non-transitory machine-readable storage medium storing an instruction,
the instruction to indicate a first source packed data that is to have a first plurality of packed data elements, a second source packed data that is to have a second plurality of packed data elements, and a destination storage location, and the instruction if executed by a machine operable to cause the machine to perform operations comprising:
storing a packed data result that is to include a plurality of packed result data elements in the destination storage location, each of the packed result data elements to correspond to a different one of the packed data elements of the second source packed data, each of the packed result data elements to include a multiple bit comparison mask, each multiple bit comparison mask to indicate results of comparisons of multiple packed data elements of the first source packed data with the packed data element of the second source that is to correspond to the packed result data element having the multiple bit comparison mask.

24. The article of manufacture of claim 23, wherein the instruction is to indicate the first source packed data that is to have N packed data elements and the second source packed data that is to have N packed data elements, and wherein the instruction if executed by the machine is operable to cause the machine to store the packed data result that is to include N, N-bit packed result data elements.

25. The article of manufacture of claim 23, wherein the non-transitory machine-readable storage medium comprises one of a non-volatile memory, DRAM, and a CD-ROM, and wherein the instruction if executed by the machine is operable to cause the machine to store the packed data result that is to indicate which among all packed data elements of the first source packed data are equal to which among all data elements of the second source packed data.
